(19) United States
(12) Patent Application Publication
(10) Pub. No.: US 2016/0285351 A1
(43) Pub. Date: Sep. 29, 2016

(54) SUSTAINABLE TORQUE SYSTEM

(71) Applicant: Bennett Ross, Bartlett, IL (US)

(72) Inventor: Bennett Ross, Bartlett, IL (US)

(21) Appl. No.: 15/081,888

(22) Filed: Mar. 27, 2016

Related U.S. Application Data
(60) Provisional application No. 62/139,671, filed on Mar. 28, 2015.

(51) Int. Cl. H02K 47/14; B60L 11/18; B60L 11/00

(52) U.S. Cl. CPC H02K 47/14; B60L 11/002; B60L 11/1811; B60L 2270/10; Y10S 74/09; H02K 53/00

(57) ABSTRACT

A sustainable torque system for providing torque or energy without the need of a combustible engine, or batteries as a continuing/ongoing energy source. The sustainable torque system may be used to propel or to drive a generator for power, or a combination of both, but not limited to the afore-mentioned. One embodiment consists of an initial power source that is connected by conductive material to an electric motor hydraulic pump system which connects via tubing to a directional flow valve which connects via tubing to a cylinder. The cylinder is connected mechanically to a rotary transmission which converts the linear strokes of the cylinder into rotational energy. A generator is connected mechanically to the rotary transmission in which the generator creates power. The generator is connected by conductive material back to the electric motor hydraulic pump system. The initial power source may now be disengaged, as the sustainable torque system is running on power from the generator.

### CROSS-REFERENCE TO RELATED APPLICATIONS

None.

### FEDERALLY SPONSORED RESEARCH

None.

### SEQUENCE LISTING

None

### FIELD OF CLASSIFICATION SEARCH

180/65.21, 180/165, 305, 307, 308

### REFERENCES CITED

U.S. Pat. No. 8,162,094 B2 4/2012 Gary Ser. No. 13/155,283

### U.S. CLASSIFICATION

180/65.2; 180/656; 180/165; 60/718; 475/2; 475/5180/243, 105/50, 180/60, 180/65.29, 903/904, 136/291, 180/65.285, 903/907, 180/65.21, 903/916, 180/65.225, 903/903, 318/139

### INTERNATIONAL CLASSIFICATION

B60K8/00, B60K23/08, B60W10/26, B60K17/356, B60K6/28, B60L8/00, B60K6/52, B60K17/04, B60K16/00, B60W10/08, B60K6/48, B60W20/00, B60L11/18, B60L11/12

### BACKGROUND

1. Field of the Embodiment

This relates to a sustainable torque system capable of generating torque that may be used to generate electricity for a wide range of industries including but limited to: the transportation industry (for example, automobiles, buses, trucks, rail, etc.) residential homes, commercial buildings, industrial plants, marine vehicles, and aeronautics, etc. The scope here relates to automotive vehicles, and more particularly to hybrid vehicles including both electric and gasoline powered propulsion means.

2. Description of the Prior Art

Combustible engines have constant and costly refueling, and are costly. There are also many controversial environmental concerns associated with fuel burning engines, ranging from global warming, toxic rain, excessive carbon emissions, air pollution, to name a few. Hybrid and battery powered vehicles have constant recharging which can take anywhere from several hours up to eight hours in some cases (on a completely depleted battery stack). Recharging the battery stack used to run an e-vehicle uses some form of energy derived from one of the following sources but not limited to: natural gas or coal burning plants, turbines from dams, solar panel farms, wind turbine farms, fossil fuel engines powering generators, etc. Large costs are associated with each of the afore-mentioned power sources ranging from: land purchases, endeavors to extract natural resources from land or off shore, construction costs of energy farms (wind turbine or solar) and construction costs associated with dam building. Some of the afore-mentioned items create additional environmental concerns to transport natural resources to the consumer for consumption.

U.S. Pat. No. 5,769,177 HYDRO ELECTRIC VEHICLE DRIVE, Dominic Wickman, Date of patent: Jun. 23, 1998 Uses a hydraulic drive system for powering a vehicle, includes a fluid circuit, a battery driven motorized pump operable to circulate fluid around the fluid circuit, a turbine-generator operably associated with the fluid circuit to generate hydro electricity, and a drive motor for driving the vehicle connectable to the turbine-generator to be powered by the hydro-electricity. The drive system may include an automatic switching system for enabling change over from charging of a first set of batteries and discharging of a second set of batteries to charging of the second set of batteries and discharging of the first set of batteries when the first set of batteries has charged above a predetermined level or the second set of batteries has discharged below a predetermined level.

U.S. Pat. No. 4,090,577 Solar celled hybrid vehicle, Wallace H. Moore, Date of patent: May 23, 1978 A front wheel driven, gas powered vehicle is converted to include a rear differential connected for power input to a first and second electrical motor, or a single electric motor if desired. When first and second electrical motors are used they are connected in parallel, the power input thereto being brought across a current limiting series of resistors to protect and control the current level thereto. A switching circuit connects in various series and parallel combinations a plurality of batteries and concurrently switches the necessary current limiting resistance. Thus a control combination is provided including a manual selector for the desired forward and reverse directions and the low and high current ranges which is further multiplied by the various resistances. In this configuration, the normally available gasoline power plant is retained in the vehicle and is augmented during periods of nonoptimal use by the above electric motor provisions. This electric power can be periodically replenished either by way of a charger or a set of solar panels placed on the roof of the vehicle.

U.S. Pat. No. 7,237,634 B2 HYBRID VEHICLES, Inventors: Alex J. Severinsky, Theodore Louckes, Date of patent: Jul. 3, 2007 A hybrid vehicle comprises an internal combustion engine, a traction motor, a starter motor, and a battery bank, all controlled by a microprocessor in accordance with the vehicle's instantaneous torque demands so that the engine is run only under conditions of high efficiency, typically only when the load is at least equal to 30% of the engine's maximum torque output. In some embodiments, a turbo charger may be provided, activated only when the load exceeds the engine's maximum torque output for an extended period; a two-speed transmission may further be provided, to further broaden the vehicle's load range. A hybrid brake system provides regenerative braking, with mechanical braking available in the event the battery bank is fully charged, in emergencies, or at rest; a control mechanism is provided to control the brake system to provide linear brake feel under varying circumstances.

U.S. Pat. No. 8,162,094 B2 HYDRAULIC HYBRID VEHICLE WITH LARGE-RATIO SHIFT TRANSMISSION AND METHOD OF OPERATION THEREOF, Inventors: Charles L. Gray, Jr., Daniel W, Barbas, Date of patent: Apr. 24, 2012 A vehicle includes an internal combustion engine configured to power a hydraulic pump to pressurize hydraulic fluid which is used to power the vehicle directly or is stored in an accumulator. A drive module, including a hydraulic pump/motor and a multi-speed mechanical transmission, is operatively coupled to drive wheels of the vehicle to provide motive power to the vehicle. The drive module can also include a second hydraulic motor (or multiple hydraulic motors) configured to provide motive power. The transmission is configured to progress through its gears at ratio shifts of no less than 2:1 between adjacent gear positions. The transmission is configured to place the hydraulic motor in neutral during some portions of vehicle operation, and to engage the motor during other portions of vehicle operation. While these devises may be suitable for the particular purpose to which they address, they are not suitable for providing a sustainable torque system that does not consist of a combustible engine, a battery stack as the continued source for powering a vehicle, a combustible engine with a generator mounted to it creating electric power, lengthy recharging time of primary battery source. In these respects, the sustainable torque system according to the first embodiment substantially departs from the conventional concepts and designs of the prior art, and in so doing provides an apparatus primarily developed for the purpose of providing a sustainable torque system that can produce torque for a number of applications without the need of a combustible engine, costly refueling, a large number of battery stacks as the continuous energy source or lengthy recharging time associated with a primary battery operated vehicle. In conclusion, insofar as I am aware, no renewable or sustainable energy source formerly developed for the automobile industry, bus industry, truck industry, residential homes, commercial buildings, industrial plants, marine vehicles, aerospace, rail transportation, etc., provides a constant source of electric power, or torque without the dependence of sun power, stored energy from batteries (as the continual energy source), combustible engine, combustible engine powered generators, etc. Items such as batteries, hydrogen fuel cells, solar panels, combustible engines, generators, etc., alone or in combination are used to extend the range of travel for combustible, electric or hybrid vehicles, while resulting in one of the following: costly refueling, timely recharging process, dependence on sun light, wave activity or wind available, costly infrastructure deployment.

### SUMMARY

In view of the forgoing disadvantages inherent in the known types of renewable energy sources now present in the prior art, the embodiments provide a new sustainable torque system construction wherein the same can be utilized for providing a sustainable energy or torque system without the need for a combustible engine or a plurality of battery as the primary energy source powering an electric motor, which propels a vehicle.

The general purpose of the included embodiments, which will be described subsequently in greater detail, is to provide a new sustainable torque system that has many of the advantages of the renewable energy sources mentioned heretofore and many novel features that result in a new sustainable torque system which is not anticipated, rendered obvious, suggested, or even implied by any of the prior art renewable energy sources.

To attain this, the embodiments generally comprise an initial power source that is connected by conductive material to a electric motor hydraulic pump system which connects via tubing to a directional flow valve which connects via tubing to a cylinder. The cylinder is connected mechanically to a rotary transmission which converts the linear strokes of the cylinder into rotational energy. A generator is connected mechanically to the rotary transmission in which the generator is now creating power. The generator is connected by conductive material to the electric motor hydraulic pump system. The initial power source may now be disengaged, as the sustainable torque system is running on power from the generator.

There has been outlined, rather broadly, the features of the embodiments in order that the detailed description thereof may be better understood, and in order that the contribution to the art may be better appreciated. There are additional features of the embodiments that will be described hereinafter and that will form the subject matter of the claims hereto.

In this respect, before explaining at least one embodiment in detail, it is to be understood that the embodiment is not limited in its application to the details of construction and to the arrangements of the components set forth in the following description or illustrated in the drawings. The embodiment is capable of other embodiments (some included) and of being practiced and carried out in various ways. Also, it is to be understood that the phraseology and terminology employed herein are for the purpose of the description and should not be regarded as limiting.

An overview of the embodiments is to provide a sustainable torque system that will overcome the shortcomings of the prior art devices.

Another thought is to provide a sustainable torque system that does not utilize a combustible engine.

An additional thought is to a provide a sustainable torque system that does not utilize a plurality of battery as the main and constant power source for energy.

A further thought is to provide a sustainable torque system that does not utilize conventional fueling procedures of a combustible engine vehicle.

Another thought is to provide a sustainable torque system that does not utilize a conventional plug in charging system to recharge a depleted battery system that is used as the primary energy source to power a conventional electric car.

To the accomplishments of the above, the embodiments in the form illustrated in the accompanying drawings, attention is being called to the fact, that the drawings are illustrative, and that changes may be made in the specific construction, sizes, materials, material hardening and grinding procedures, fastener types, brackets, wires, items may be combined, order of the items listed or illustrated and described, etc., within the scope of the appended claims.

Accordingly several advantages of one or more aspects are as follows: the sustainable torque system has a low operating cost, and does not have costly refueling or lengthy recharging time of batteries used as the primary energy source. The sustainable torque system does not have a large number of batteries as a continued energy source for providing power, and does not use a combustible engine to generate torque. It does not have lengthy plug in time to recharge the system in order for the user to enjoy the product. Other advantages of one or more aspects will be apparent from a consideration of the drawings and ensuing description.

### BRIEF DESCRIPTION OF THE DRAWINGS

Various other features and attendant advantages of the embodiments will become fully appreciated as the same becomes better understood when considered in conjunction with the accompanying drawings, in which like reference characters designate the same or similar parts throughout the several views, and wherein:

FIG. 1 is an isometric view of the first embodiment.

FIG. 2 is an isometric view of the first embodiment with exposed workings.

FIG. 3 is an isometric view of the first embodiment cylinder assembly and linear to rotational box.

FIG. 4 is an isometric view of the first embodiment cylinder assembly and linear to rotational box with exposed and exploded workings.

FIG. 5 is a top view of the first embodiment cylinder assembly and linear to rotational box with cross section direction markers.

FIG. 6 is an isometric cross section view of the first embodiment representing arrows A-A, of FIG. 5.

FIG. 7 is an isometric cross section view of the first embodiment representing arrows B-B, of FIG. 5.

FIG. 8 is a basic wiring schematic of the first embodiment connections between the power supply, torque system pump motor and generator.

FIG. 9 is a basic wiring schematic of the other embodiments connections between the power supply, control box, torque system pump motor (optional directional valve power supply) and generator.

FIG. 10 is an upper rear perspective of the second embodiment.

FIG. 11 is an magnified upper rear perspective of the second embodiment with exposed workings.

FIG. 12 is an upper rear perspective displaying optional power source of the second embodiment.

FIG. 13 is an upper front perspective of the third embodiment.

FIG. 14 is an upper rear perspective of the third embodiment.

FIG. 15 is a magnified isometric rear perspective of the third embodiment with exploded workings.

FIG. 16 is a rear perspective of an illustration of inner workings of the third embodiment (ref. FIG. 15).

FIG. 17 is an upper isometric view of the fourth embodiment.

FIG. 18 is an magnified upper isometric view of the fourth embodiment.

FIG. 19 is a magnified isometric rear perspective of the fourth embodiment with an illustration of exploded workings.

FIG. 20 is an illustration isometric cross section view of the fourth embodiment representing arrows C-C, (ref. FIG. 17).

FIG. 21 is an isometric view of a fifth embodiment.

FIG. 22 is an isometric exploded view of a fifth embodiment with an illustration of exploded workings.

### DETAILED DESCRIPTION OF FIRST EMBODIMENT

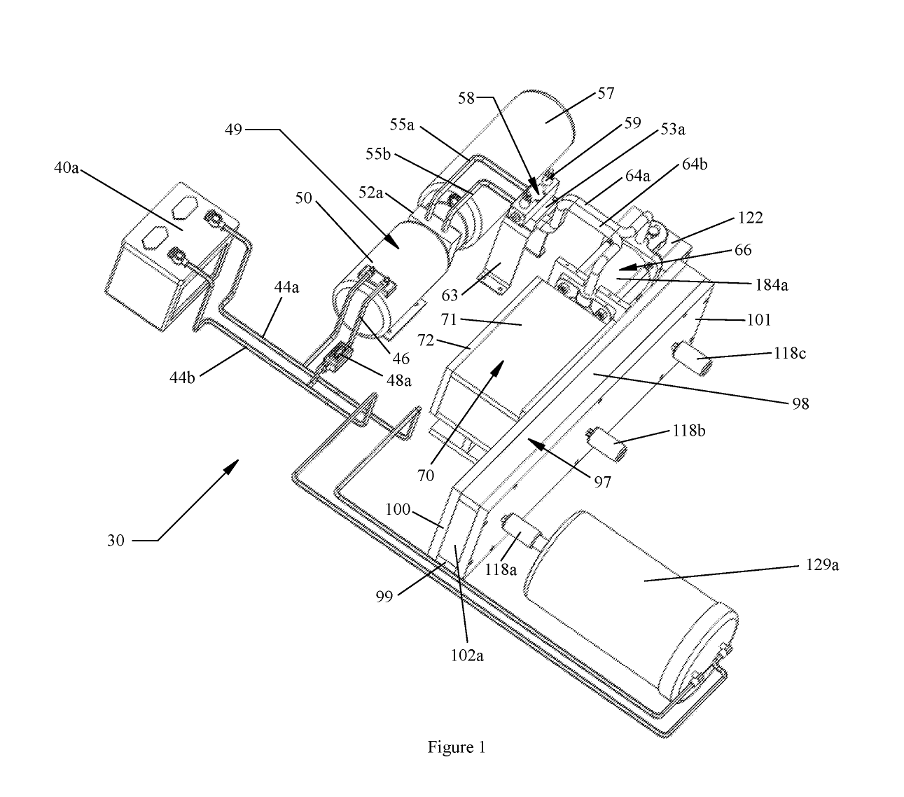

Turning descriptively to the drawings, in which similar reference characters denote similar elements throughout the several views, FIGS. 1 through 8 illustrate a sustainable torque system-1 30, which comprises a power source, battery 40a, connected by conductive wires 44a and 44b. Conductive wire 44b connects to on/off switch 48a, which connects to conductive wire 46. Conductive wire 46 and conductive wire 44a connects to hydraulic pump motor assembly 49. Hydraulic pump assembly 49 connects to flow tubings 55a and 55b which connects to auto reciprocating valve assembly 58, which connects to flow tubing large 64a and 64b, and flow tubing large 64a and 64b connects to cylinder assembly 66, which connects to linear to rotational box 70, which connects to transfer assembly 97, which connects to shaft sleeve lock 118a. Shaft sleeve lock 118a connects to dc generator 129a which connects to conductive wires 44a, 44b and on/off switch 48a. On/off switch 48a connects to conductive wire short 46. Wire short 46 and conductive wire 44a connects to hydraulic pump assembly 49. Conductive wires 44a or 44b may be disconnected from power source, battery 40a, allowing energy from dc generator 129a to power sustainable torque system-1 30.

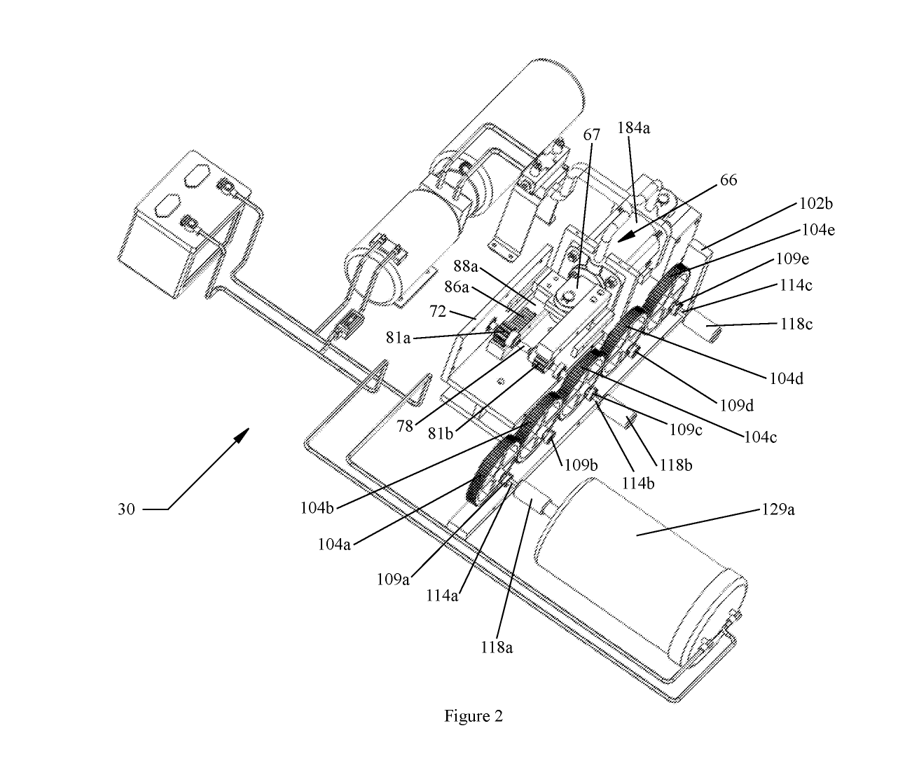

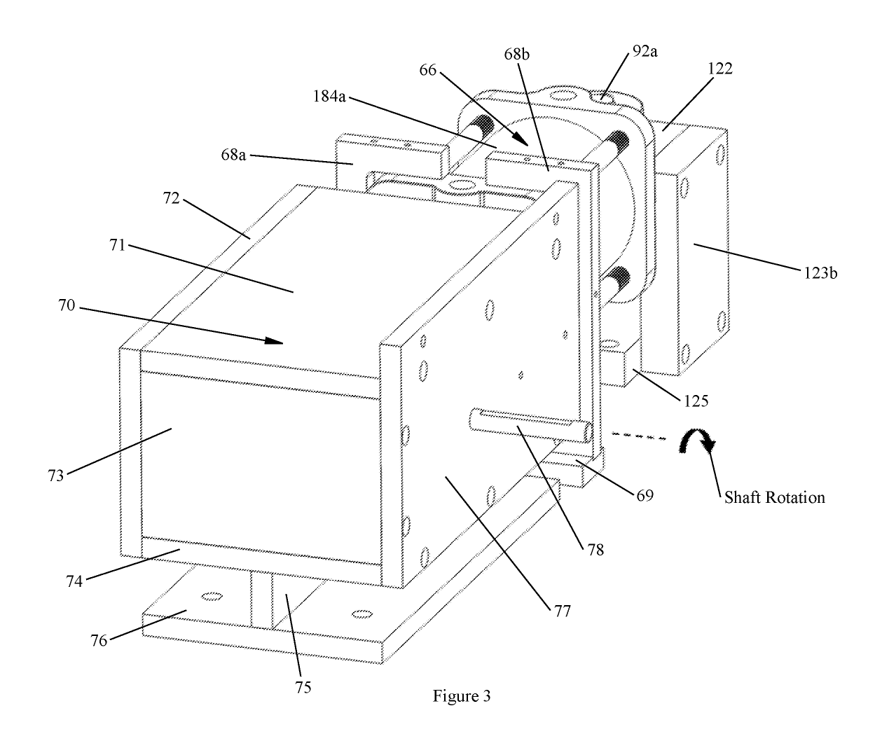

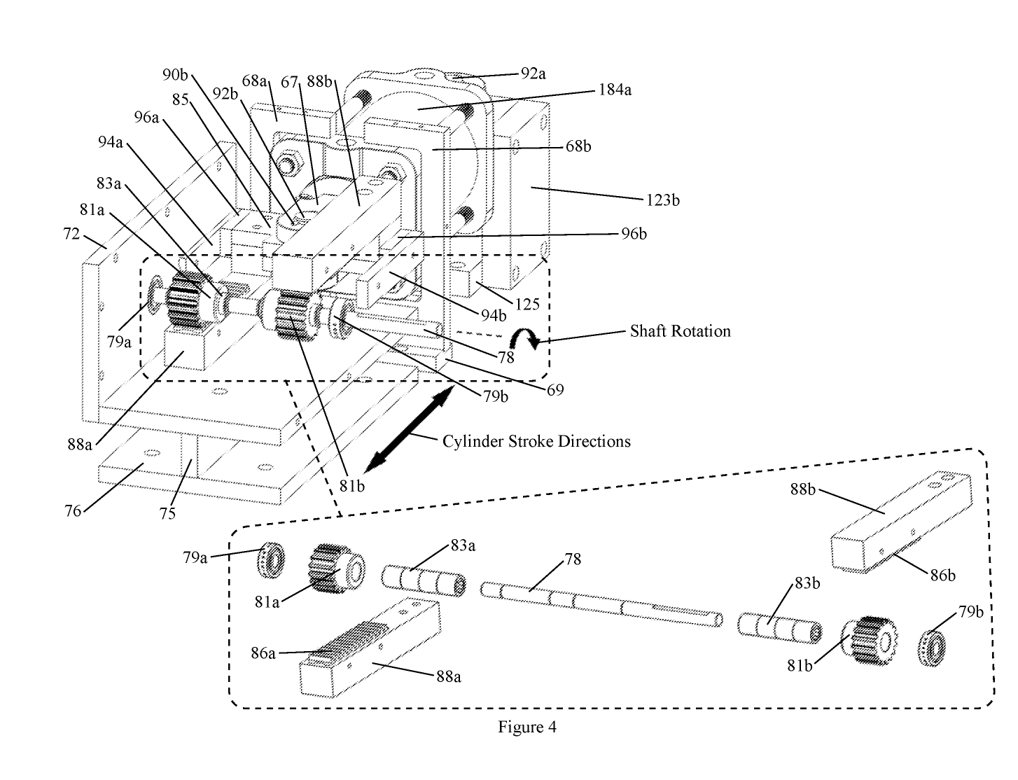

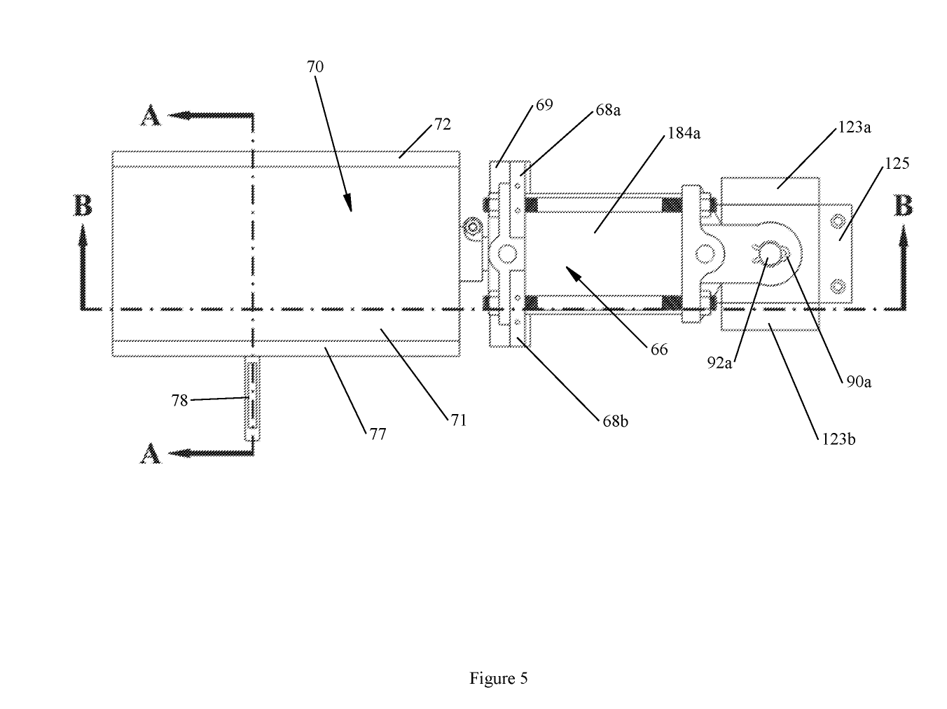

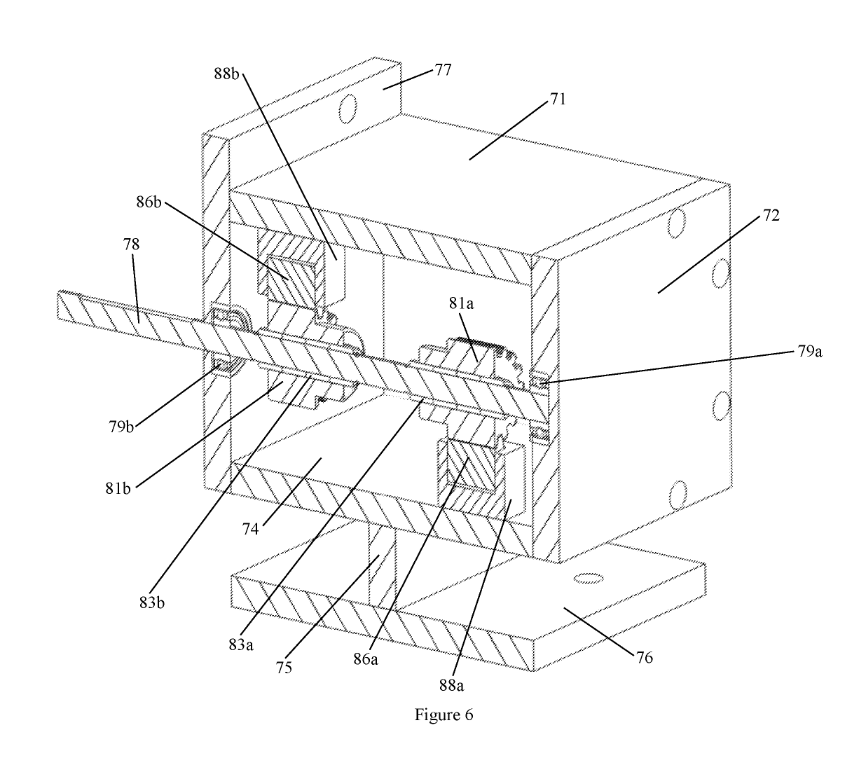

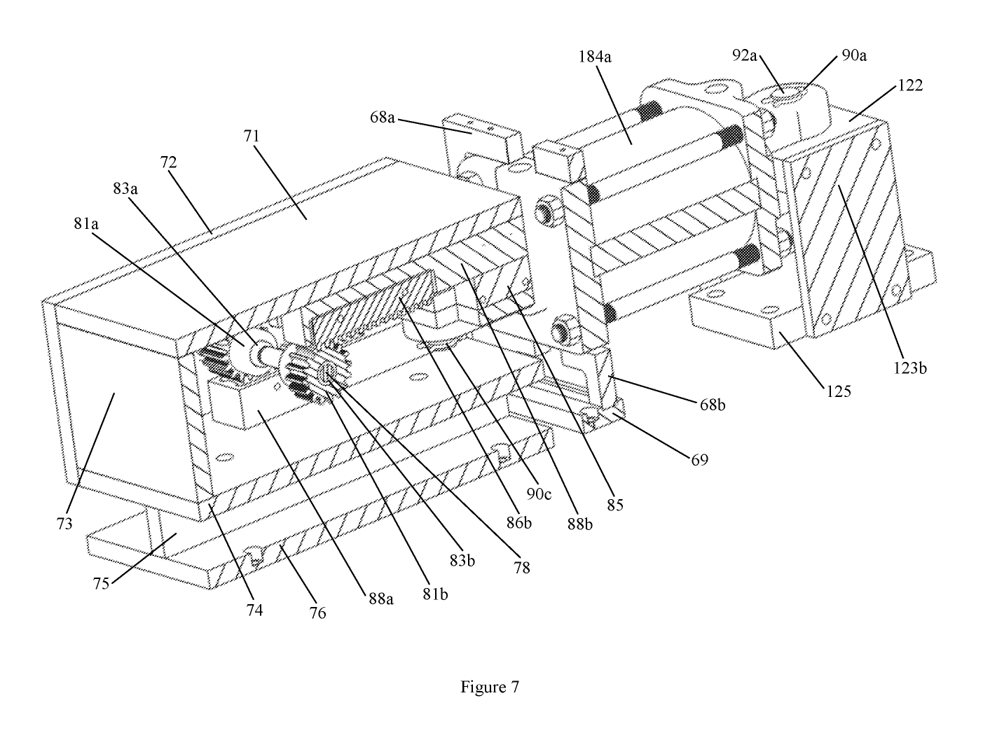

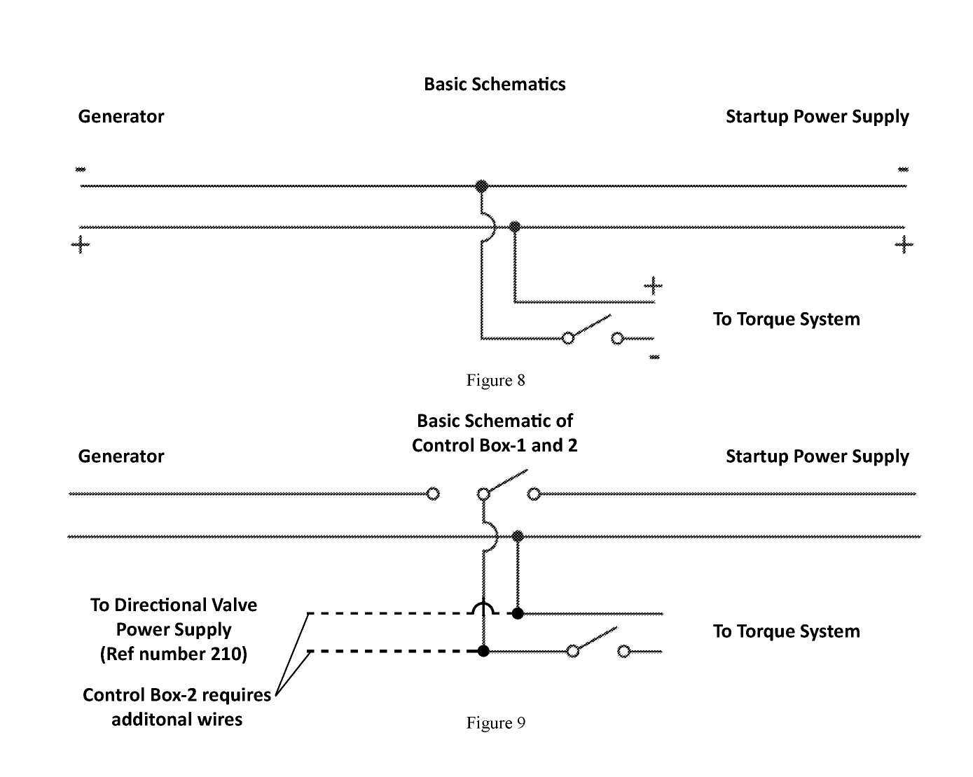

As shown in FIGS. 1 through 8 of the drawings representing sustainable torque system-1 30 (FIG. 1) power source, battery 40a is comprised of any well-known design and materials. Battery 40a connects to conductive wires 44a and 44b with a nut and bolt. Conductive wires 44a, 44b and 46 are constructed of copper wire with suitable connecting ends (for mating to adjacent components) comprised of steel alloy and crimped to the end of the copper wire. The copper wire has an outer insulated casing comprised of any well-known flexible material. On/off switch 48a is soldered, crimped or nut and screw fastened (not shown) to conductive wires 44b and 46 respectively. Conductive wires 44a, and 46 are connected by screw fasteners to hydraulic pump dc motor 50, comprised of well-known design and materials, hydraulic pump assembly 49 comprised of a hydraulic pump dc motor 50, directional flow block short 52a, a mechanical pump assembly (not shown) and a pump reservoir 57, comprised of steel alloy welded together. Directional flow block long 52a (comprised of aluminum alloy and steel set screw) of hydraulic pump assembly 49 connects mechanically to high pressure resistant (outlet) flow tubings 55b and (inlet/return) 55a comprised of any well-known material. Flow tubings 55b and 55a connects mechanically to directional flow block short 53a (comprised of aluminum alloy) which is socket head screw fastened to an automatic reciprocating valve 59. Automatic reciprocating valve 59, provides a predetermined adjustable pressure setting, once reached, reverses the flow direction, comprised of well-known design and material. Enabling directional flow block short 53a ports adjacent to flow tubing large 64a and 64b to act as an inlet or outlet ports respectively. Directional flow block short 53a, connected with socket head cap screws to support bracket 63 (comprised of steel alloy), and connects mechanically to high pressure resistant flow tubing large 64a and 64b comprised of any well-known material. Flow tubing large 64a and 64b connects mechanically to a high pressure resistant cylinder 184a, comprised of well-know design and materials. As shown in FIGS. 2 through 4, linear to rotational box 70, taking note of the cylinder end component, bracket end rod 67 connects single connect arm 85 which is comprised of steel alloy, affixed by pin 92b, pin clip 90b and 90c (both comprised of steel alloy), via a through hole (not shown) in both bracket end rod 67 and single connect arm 85. Adjacent to single connect arm 85 are steel alloy guide ways, ways shorts 96a and 96b affixed to single connect arm 85 with recessed screw fasteners. Opposing ways short 96a and 96b are ways long 94a and 94b respectively (both comprised of steel alloy). Ways long 94a connects with screw fasteners to a recessed slot cutaway of housing back plate 72 (comprised of steel alloy), ways long 94b connects in the same manner to housing front plate 77. Rack gears 86a and 86b comprised of hardened steel alloy and precision ground, and rack gear holders 88a and 88b comprised of steel alloy, are affixed with screw fasteners. Rack gear holders 88a and 88b are affixed with socket head cap screws to single connect arm 85 respectively. Housing back plate 72 has a depth hole that receives bearing assembly-2 79a that are well-known in the art, which is press fitted into position. Bearing assembly-2 79b assembles in the same manner with housing front plate 77. Turning to the exploded section in FIG. 4, spur gears 81a and 81b are hardened gears and precision ground, that receive press fit roller clutch bearings 83a and 83b respectively, that are well-known in the art. Main shaft 78, comprised of precision ground hardened steel alloy, which is slip fitted through roller clutch bearings 83a and 83b respectively, with one end of main shaft 78 is press fitted to bearing assembly-2 79a, and the opposite end slip fitted through bearing assembly 79b. As shown in FIG. 3, housing top plate 71, housing back plate 72, housing side plate 73, housing bottom plate 74, housing support plate 75, housing mount plate 76, housing front plate 77, all comprised of steel alloy, affixed respectively, with socket head cap screws. Cylinder support top plate 122 (has a through hole centered), cylinder support side plate 123b, cylinder support side plate 123a (not shown), and cylinder support base plate 125, all comprised of steel alloy are affixed with socket head cap screws respectively, to form a support mount for cylinder 184a. Cylinder 184a has a bracket slot end (opposite end of bracket rod end 67) and a through hole which connects to cylinder support top plate 122 (also having a through hole), affixed by pin 92a and pin clip 90a (not shown) both comprised of steel alloy. Cylinder brackets 68a and 68b, cylinder bracket base 69 are comprised of steel alloy and are affixed with socket head cap screws, respectively, to form a support for the frontal portion of cylinder 184a. As shown in FIGS. 1 and 2, main shaft 78 slip fits through a hole in back plate 100, comprised of transfer assembly 97 (plates 98 through 102b are comprised of steel alloy). Back plate 100 and front plate 101 have 5 depth holes each, to receive press fit bearing assembly 109a-j respectively (bearing assembly 109f-j not shown), bearing assembly 109a-j are well-known in the art. Gear 104a-e are comprised of hardened steel alloy with precision ground teeth, each having a through hole to receive drive shaft 114a-c and short shaft 115a-b (not shown), shafts comprised of hardened steel alloy with flats to receive set screws. Shaft ends are designed with either slip fit or press fit tolerances, depending on assembly requirements. Plates 98 though 102a-v are affixed with socket head cap screws respectively. Housing front plate 77 attaches to back plate 100 with socket head cap screws. As shown in FIG. 2, Drive shafts 114a-c connects with set screws (not shown) to shaft sleeve locks 118a-c (comprised of steel alloy). Shaft sleeve lock 118a connects with a set screw (not shown) to dc generator 129a shaft (dc generator 129a comprised of well-known design and materials). Conductive wires 44a and 44b are affixed to two threaded rod ends protruding from dc generator 129a with steel alloy nuts (not shown). Shaft sleeve locks 118b and 118c are open to receive other devices that operate using torque, e.g. transmissions, generators, etc. As shown in FIGS. 5 thought 7, FIG. 5 represents the top view of cylinder assembly 66 and linear to rotational box 70, with cross section indicators A-A and B-B. As shown in FIG. 6, illustrates a lateral cross-section through linear to rotational box 70 at section line A-A location. The isometric illustration represents the location of the assembled components and functionality. As shown in FIG. 7, illustrates the longitude cross-section through cylinder assembly 66 and linear to rotational box 70, at section line B-B. The isometric illustration represents the location of the assembled components and functionality. As shown in FIG. 8, a basic schematic connects power supply (battery 40a) to torque system motor (hydraulic pump dc motor 50) and generator (dc generator 129a). The above sustainable torque system process continues until the user desires to no longer utilize the first embodiment (represented in FIG. 1). Removing the connection between the power source (battery 40a) and one of the conductive wires 44a or 44b will disable the system. Another way to discontinue use, is to toggle on/off switch 48a to the off position. It can be appreciated by one skilled in the art that the sustainable torque system-1 30, with respect to the above description then, it is to be realized that the optimum dimensional relationships for the parts of sustainable torque system-1 30, to include variations in size, materials, shape, form, function and manner of operation, assembly and use, are deemed readily apparent and obvious to one skilled in the art, and all equivalent relationships to those illustrated in the drawings and described in the specification are intended to be encompassed by the first embodiment. Therefore, the foregoing is considered as illustrative only of the principles of the embodiment. Further, since numerous modifications and changes will readily occur to those skilled in the art, it is not desired to limit the embodiment to the exact construction and operation shown and described, and accordingly, all suitable modifications and equivalents may be resorted to, falling within the scope of the embodiment.

### Second Embodiment

Turning now descriptively to the drawings, in which similar reference characters denote similar elements throughout the several views, FIGS. 9, through 12 illustrate a sustainable torque system-2 156, which comprises a power source, battery assembly 41, connected by conductive wires 160a and 160b to inverter/converter 164, which is connected to ac wire 168a, which connects to control box-1 176. Control box-1 176 connects to ac wire 168c which connects to hydraulic pump assembly ac 180. Hydraulic pump assembly ac 180 connects to flow tubings 55a and 55b, which connects to auto reciprocating valve assembly 58, which connects to flow tubing long 182a and 182b, which connects to multiple cylinder assembly 183. Multiple cylinder assembly 183 connects mechanically to linear to rotational box 70, which connects mechanically to rotary transmission assembly 188, which connects mechanically to transfer assembly 97, which connects mechanically to shaft sleeve lock 118a, which connects mechanically to ac generator 150b. Ac generator 150b connects to ac wire 168b which connects to control box-1 176. Rotate lever on control box-1 176 to generator setting. Energy from ac generator 150b powers sustainable torque system-2 156.

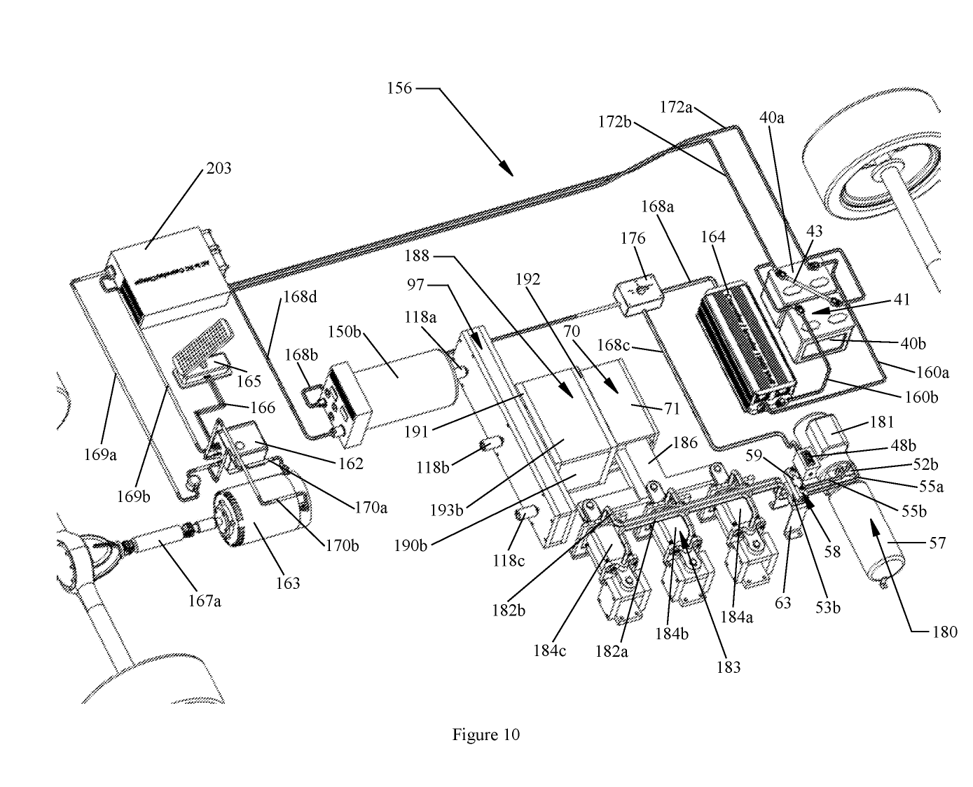

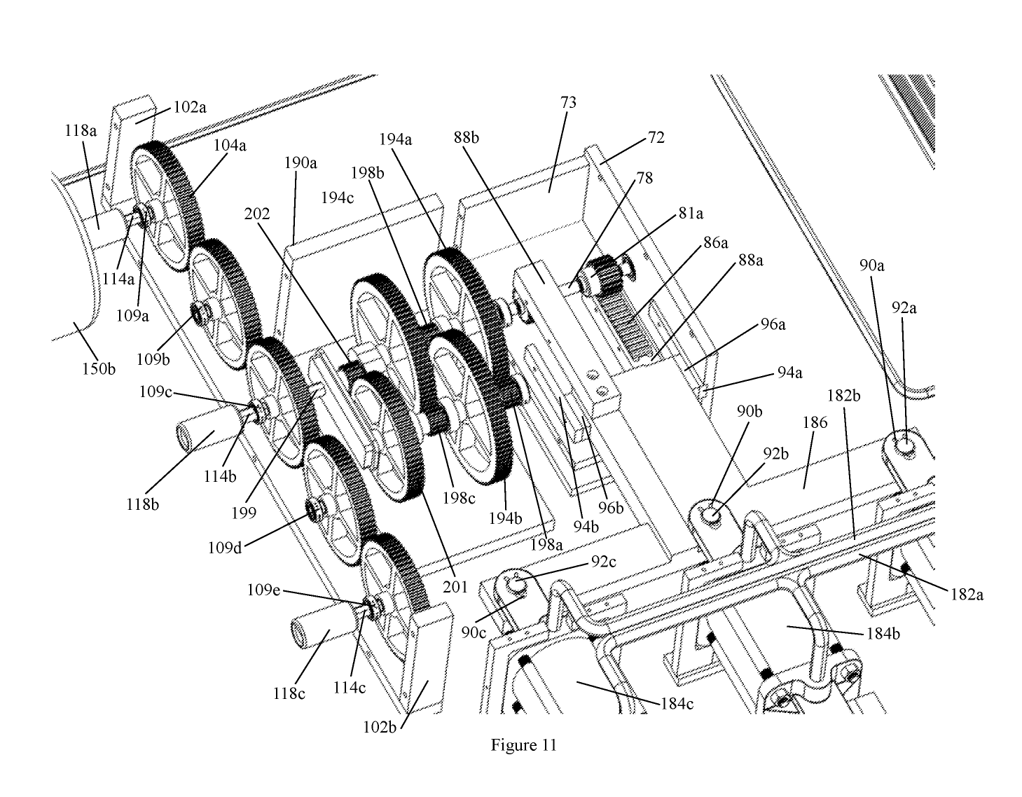

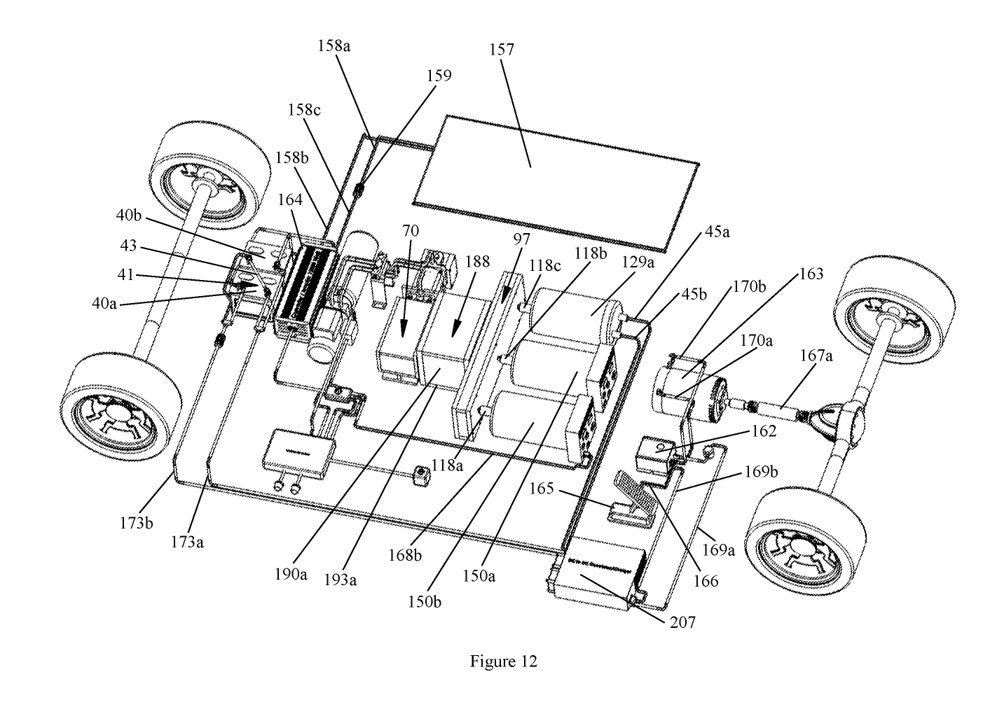

As shown in FIGS. 9 through 12 of the drawings representing sustainable torque system-2 156, power source, battery assembly 41 is a combination of battery 40a and 40b, comprised of any well-known design and materials. Battery 40a and 40b are connected by cross conductive wire 43, comprised of a copper wire with suitable connecting ends (for mating to adjacent components) comprised of steel alloy and crimped to the end of the copper wire. The copper wire has an outer insulated casing comprised of any well-known flexible material (note: all electrical wires are described in the manner, including this embodiment and all further detail description embodiments unless otherwise described). Battery 40a and 40b are connected by cross conductive wire 43, nut and bolt connection with end fittings. Battery 40a and 40b are connected to inverter wires 160a and 160b respectively, nut and bolt connection with end fittings. Inverter wires 160a and 160b are connected to inverter/converter 164 respectively, nut and bolt connection with end fittings. An optional power source (As shown in FIG. 12), solar panel 157 comprised of well-known design and materials, connected to solar wires 158a and 158b, soldered or screw fastened to solar panel 157, solar wire 158b connects to solar toggle switch on/off 159, comprised of well-known design and materials, connects to solar wire 158c, soldered or screw fastened. Solar wires 158b and 158c connects to inverter/converter 164 respectively, with nut and bolt connection with end fittings. As shown in FIG. 10, inverter/converter 164, comprised of any well-know design and material (the inverter, in this case, inverters the dc power from battery assembly 41 into alternating current). Ac wire 168a connects to Inverter/Converter 164 with nut and bolt connection with end fittings, ac wire 168a and 168c connects to control box-1 176 with bracket and screws (not shown), ac wire 168c connects to on/off switch 48b, which is soldered, crimped or nut and screw fastened (not shown) to ac wire 168c respectively, which is a part of pump ac motor 181. Hydraulic pump assembly ac 180 is comprised of pump ac motor 181, directional flow block short 52b, a mechanical pump assembly (not shown) and a pump reservoir 57. Directional flow block long 52b (comprised of aluminum alloy) of hydraulic pump assembly ac 180, connects mechanically to high pressure resistant (outlet) flow tubings 55b and (inlet/return) 55a comprised of any well-known material. Flow tubings 55b and 55a connects mechanically to directional flow block short 53b (comprised of aluminum alloy) which is socket head screw fastened to automatic reciprocating valve 59. Automatic reciprocating valve 59, provides a predetermined adjustable pressure setting which, once reached, reverses the flow direction (comprised of well-known design and material). Enabling directional flow block short 53b ports adjacent to flow tubing long 182a and 182b to act as inlet or outlet ports, respectively. Directional flow block short 53b connects mechanically to high pressure resistant flow tubing long 182a and 182b comprised of any well-known material. Flow tubing long 182a and 182b connects mechanically to high pressure resistant cylinders 184a, 184b and 184c. Cylinders 184a, 184b and 184c connect mechanically to multiple connect arm 186, which is comprised of steel alloy, affixed by pins 92a-c and pin clips 90a-f (both comprised of steel alloy). Adjacent and connected to multiple connect arm 186 are steel alloy guide ways, ways short 96a and 96b affixed to single connect arm 186 with recessed screw fasteners. As shown in FIGS. 3 and 4, linear to rotational box 70 is detailed and described in the first embodiment and may be applied here in the second embodiment as well as other included embodiments. Housing front plate 77 (of linear to rotational box 70) is connected with socket head cap screws to transmission back plate 192, comprised of steel alloy. Transmission back plate 192 is part of rotary transmission assembly 188. Rotary transmission assembly 188 (as shown in FIG. 11) may represent a step-up or step-down rotary transmission. A combination of gears, (end gear large 201, end gear small 202, transmission gear large 194a-c, transmission gear small 198a-c, comprised of hardened steel alloy with precision ground teeth) bearings, shafts, set screws, spacer plates, etc. make up the illustration of the rotary transmission assembly 188 (but not limited to the afore-mentioned items), which is comprised of any well-known design, materials and heat treatment (where applicable), that are well-known in the art. As shown in FIGS. 10 and 11 (FIGS. 1 and 2 for referencing), transmission front plate 191 connects to back plate 100 with socked head cap screws, transition shaft 199 slip fits through a hole in back plate 100 (transmission plates 190a through 194c are comprised of steel alloy and affixed respectively, with socket head cap screws). Back plate 100 and front plate 101 have 5 depth holes each to receive press fit bearing assembly 109a-j respectively (bearing assembly 109f-j not shown), bearing assembly 109a-j are well-known in the art. Gear 104a-e are comprised of hardened steel alloy with precision ground teeth, with each gear having a through hole to receive drive shafts 114a-c and short shafts 115a-b (not shown), shafts comprised of hardened steel alloy with flats to receive set screws. Shaft ends are designed with either slip fit or press fit tolerances depending on assembly requirements. Plates 98 though 102a-b are affixed with socket head cap screws respectively. Drive shafts 114a-c connect with set screws (not shown) to shaft sleeve locks 118a-c, comprised of steel alloy. As shown in FIG. 10, shaft sleeve lock 118a connects with a set screw (not shown) to ac generator 150b shaft (generator comprised of well-known design and materials). Ac wire 168b is affixed to ac generator 150b by plug or with screws and connecting end comprised of steel alloy. Ac wire 168b connects to control box-1 176 by bracket and screws (not shown). Ac wire 168d connects to ac generator 150b and then connects to ac/dc converter and charger 203, comprised of well-known design and materials. Charging wires 172a and 172b (comprised of a copper wire with suitable connecting ends comprised of steel alloy, crimped to the end of the copper wire, the copper wire has an outer insulated casing comprised of any well-known flexible material) connects to ac/dc converter and charger 203 and to battery assembly 41. Dc controller wire 169a and 169b connects to ac/dc converter and charger 203 and to throttle/motor controller 162 (controller comprised of well-known design and materials). Controller motor wire 170a and 170b connects to throttle/motor controller 162 and to dc motor 163 (comprised of well-known design and materials). Throttle wire 166 connects to throttle 165 (comprised of well-known design and materials) and to throttle/motor controller 162. Dc motor 163 connects mechanically to drive train 167a, comprised of well-known design and materials. Shaft sleeve locks 118b and 118c are open to receive other devices that uses torque to operate, e.g. transmissions, generators, propellers, etc. As shown in FIG. 12, shaft sleeve lock 118a connects with a set screw (not shown) to ac generator 150b shaft, shaft sleeve lock 118b connects with a set screw (not shown) to ac generator 150a shaft, and shaft sleeve lock 118c connects with a set screw (not shown) to dc generator 129a shaft (generators comprised of well-known design and materials). Dc wires 45a and 45b are affixed to dc generator 129a by nut and bolt with suitable connecting ends, comprised of steel alloy. Dc wires 45a and 45b connects (with set screws) to dc/dc converter and charger 207, comprised of well-known design and materials. Charging wires long 173a and 173b, (comprised of a copper wire with suitable connecting ends comprised of steel alloy, crimped to the end of the copper wire, the copper wire has an outer insulated casing comprised of any well-known flexible material), connects dc/dc converter and charger 207 to battery assembly 41. Dc controller wire 169a and 169b connects dc/dc converter and charger 207. Controller motor wires 170a and 170b connects to throttle/motor controller 162 (controller comprised of well-known design and materials), and dc motor 163 (comprised of well-known design and materials). Throttle wire 166 connects to throttle 165 (comprised of well-known design and materials) and to throttle/motor controller 162. Dc motor 163 connects mechanically to drive train 167a, comprised of well-known design and materials. Shaft sleeve locks 118a-c are may receive other devices that uses torque to operate, e.g. transmissions, propellers, etc. As shown in FIG. 10, Power is generated from ac generator 150b, the user may now turn the toggle switch on control box-1 176 from power supply to generator. After switching the setting, the sustainable torque is running on generator power. The power supply, battery assembly 41, is no longer needed to run the system. As shown in FIG. 9, basic schematic for connecting power supply (battery assembly 41) to the torque system motor (pump ac motor 181) and the generator (dc generator 150b). The above sustainable torque system process continues until the user desires to no longer utilize the second embodiment (As shown in FIG. 10) by removing the connection between the power source, battery assembly 41 and one of the conductive wires 160a or 160b. Another way to discontinue use, is to toggle on/off switch 48b to the off position. With respect to the sustainable torque system-2 156 described above, that the optimum dimensional relationships for the parts of sustainable torque system-2 156, to include variations in size, materials, shape, form, function and manner of operation, assembly and use, are deemed readily apparent and obvious to one skilled in the art, and all equivalent relationships to those illustrated in the drawings and described in the specification are intended to be encompassed by this embodiment. Therefore, the foregoing is considered as illustrative only of the principles of the embodiment. Further, since numerous modifications and changes will readily occur to those skilled in the art, it is not desired to limit the embodiment to the exact construction and operation shown and described, and accordingly, all suitable modifications and equivalents may be resorted to, falling within the scope of the embodiment.

### Third Embodiment

Turning now descriptively to the drawings, in which similar reference characters denote similar elements throughout the several views, FIGS. 9, 13 through 16 illustrate a sustainable torque system-3 204, which comprises a power source, battery assembly 41, connected by conductive wires 160a and 160b to inverter/converter 164, which is connected to ac wire 168a, which connects to control box-2 177. Control box-2 177 connects to ac wire 208, which connects to hydraulic pump/cylinder assembly 205, control box-2 177 also connects to directional valve power supply wire 206. Hydraulic pump/cylinder assembly 205 connects mechanically to rotary transmission assembly 188, which connects mechanically to transfer assembly 97, which connects mechanically to shaft sleeve lock 118a, which connects to ac generator 150c. Ac generator 150c connects to ac wire 168b, which connects to control box-2 177. Rotate lever on control box-2 177 to generator setting. Energy from ac generator 150c powers sustainable torque system-3 204.

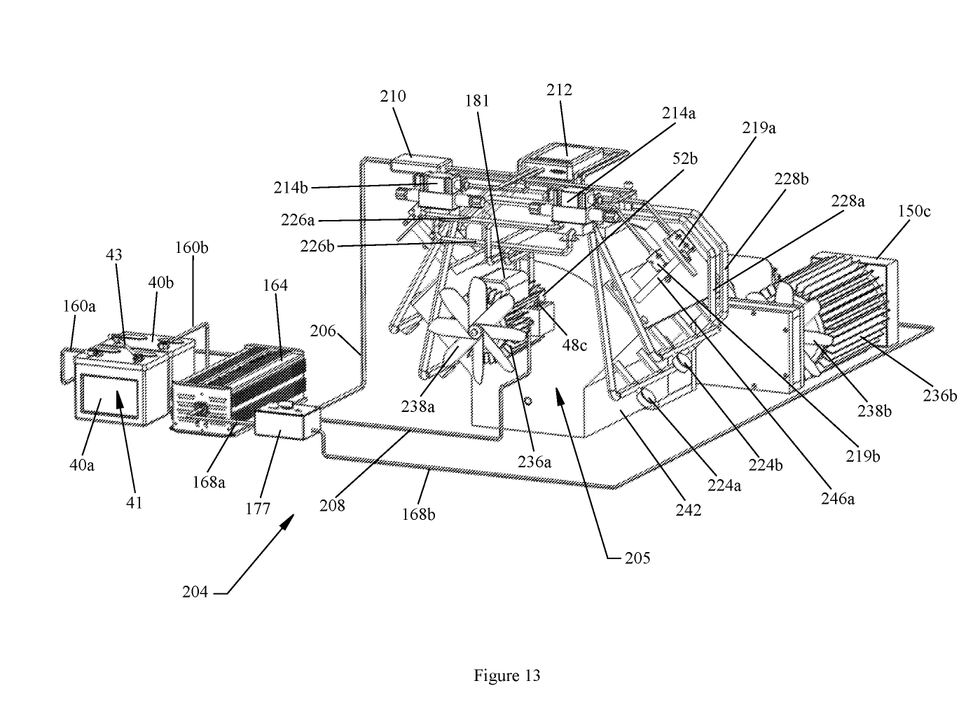

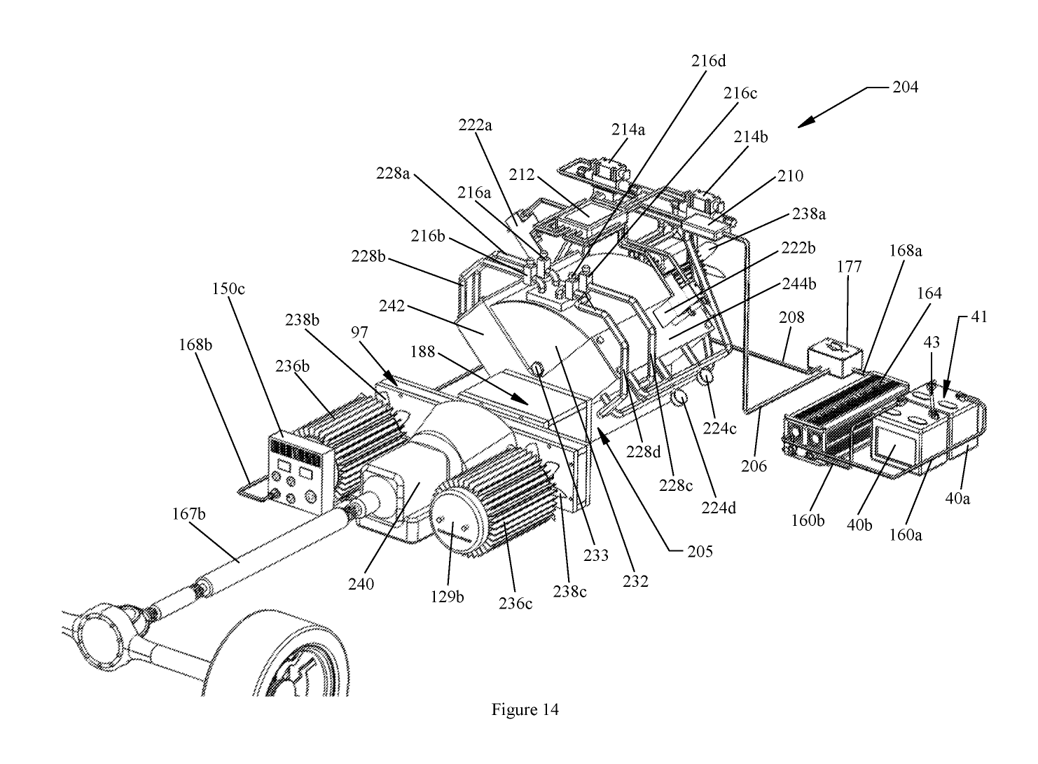

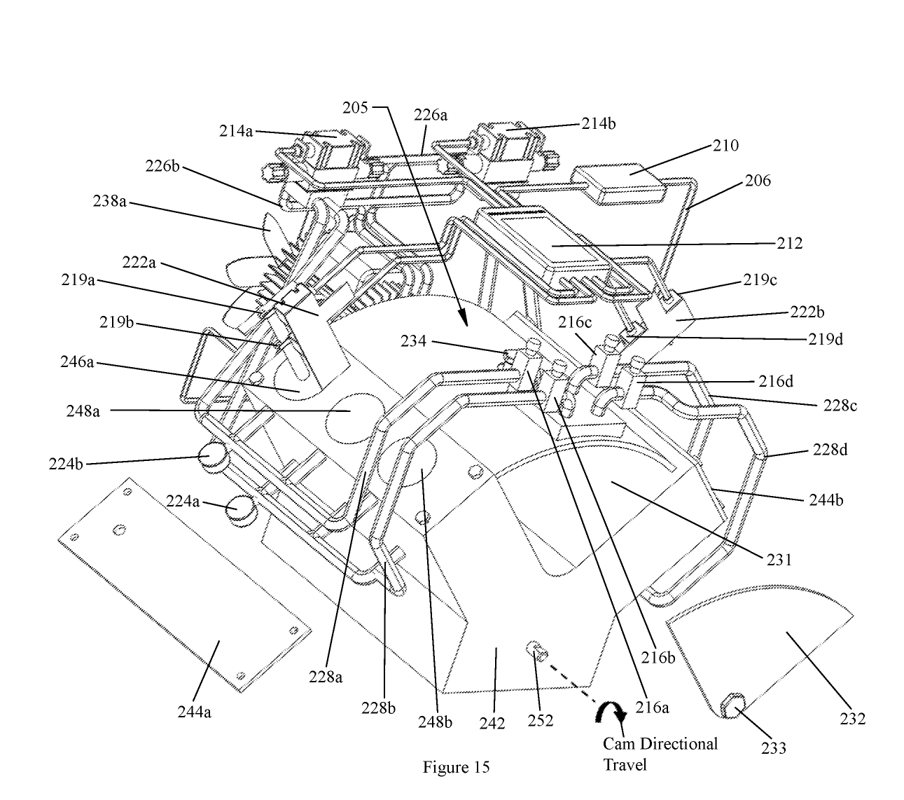

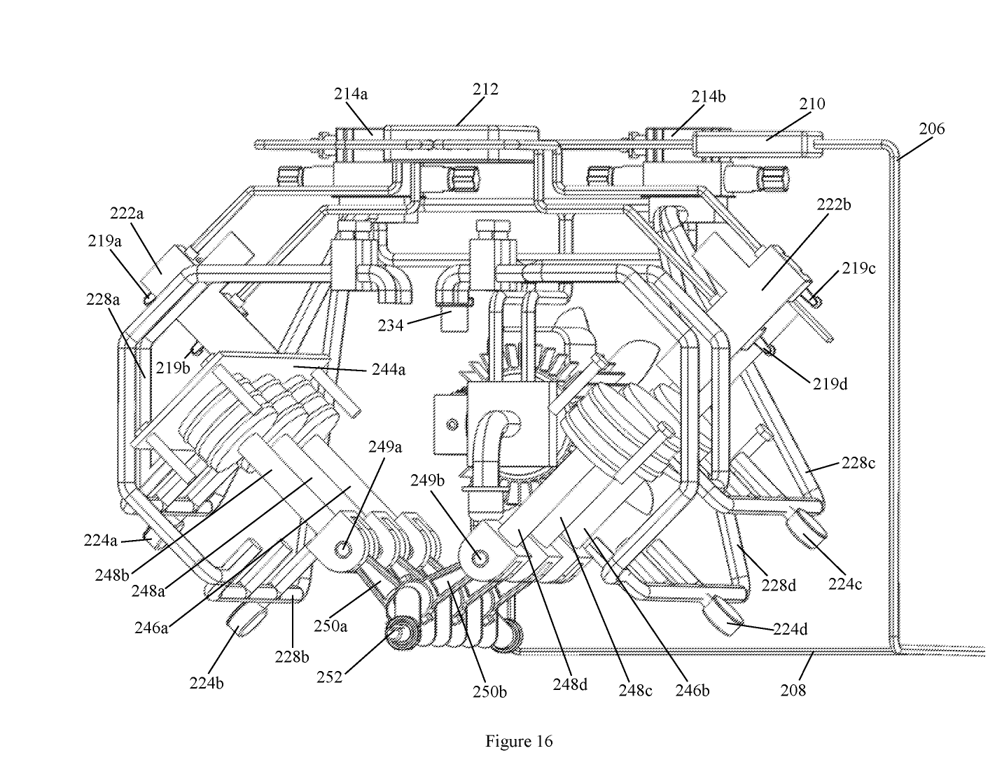

As shown in FIGS. 9, 13 through 16 of the drawings representing sustainable torque system-3 204, power source, battery assembly 41 is a combination of battery 40a and 40b and is comprised of any well-known design and materials. Battery 40a and 40b are connected by cross conductive wire 43 comprised of a copper wire with suitable connecting ends (mating to adjacent components), comprised of steel alloy and crimped to the ends of the copper wire. The copper wire has an outer insulated casing comprised of any well-known flexible material (note: all electrical wires are described in the manner, including this embodiment and further detail description embodiments unless otherwise described). Battery 40a and 40b are connected with cross conductive wire 43, by nut and bolt with end fittings. Battery 40a and 40b are connected to inverter wires 160a and 160b respectively, by nut and bolt with end fittings. Inverter wire 160a and 160b are connected to inverter/converter 164 respectively, by nut and bolt with end fittings. Inverter/Converter 164, comprised of any well-know design and material (the inverter, in this case, inverts the dc power from power source, battery assembly 41 to ac current). Ac wire 168a connects to Inverter/Converter 164 by nut and bolt with end fittings, ac wires 168a and 168b, and pump motor power wire 208 connects to control box-1 177 by bracket and screws (not shown). Pump motor power wire 208 connects to on/off switch 48c. On/off switch 48c is soldered, crimped or nut and screw fastened (not shown) to ac wire 168c respectively, which is part of pump ac motor 181. Hydraulic pump assembly ac-2 205 is comprised of the following items, pump ac motor 181 (comprised of any well-known design and materials), heat sink 236a (comprised of aluminum alloy), motor cooling fan 238a (comprised of steel alloy) connected to pump ac motor 181 shaft with a nut, directional flow block short 52b which is connected by socket head cap screws to a mechanical pump assembly (not shown). Directional flow block short 52b is comprised of aluminum alloy, which connects with socket head cap screws to cylinder block 242 (comprised of steel alloy). As shown in FIGS. 14 and 15, cylinder block 242 has a reservoir channel 231, that stores fluid to be pumped. Reservoir cover plate 232 (comprised of steel alloy) connects to cylinder block 242 with socket head cap screws (not shown). Reservoir cover plate 232 has a reservoir drain cap 233 (comprised of plastic, e.g., abs, pvc, etc.) is screwed into place. Reservoir fill cap 234 (comprised of plastic, e.g., abs, pvc, etc.) is screwed into place at the top portion of cylinder block 242. As shown in FIG. 13, directional flow block short 52b connects mechanically to high pressure resistant (outlet) flow tubings 226b and (inlet/return) 226a comprised of any well-known material. Flow tubing 226b connects mechanically to directional valve assembly 214a and 214b inlet ports. Flow tubing 226a connects mechanically to directional valve assembly 214a and 214b return ports. Directional valve assembly 214a and 214b connects to directional valve controller 212 by conductive wires. Directional valve controller 212, comprised of well-known design and material, connects by conductive wire to directional valve power supply 210, comprised of well-known design and material. Directional valve power supply 210 connects to directional valve power supply wire 206, which connects to control box-2 177. Directional valve controller 212 connects by conductive wires to limit switch 219a-d (comprised of any well-known design and material). Limit switch 219a and 219b (comprised of any well-known design and material) connects to switch bracket 222a, comprised of steel alloy. Limit switch 219c and 219d (comprised of any well-known design and material) connects to limit switch bracket 222b, comprised of steel alloy. Switch bracket 222b is welded to cylinder block plate 244b, comprised of steel alloy and switch bracket 222a is welded to cylinder block plate 244a, comprised of steel alloy. Block plates 244a and 244b are connected to cylinder block 242 with bolt screws comprised of steel alloy. Directional valve assembly 214a connects to shaped flow tubings 228a and 228b (comprised of high pressure resistant well-known material), flow tubings 228a and 228b connects mechanically to cylinder block 242. Pressure gauges 224a and 224b (comprised of any well-known design and materials) are connected mechanically to flow tubings 228a and 228b. Flow tubings 228a and 228b are connected mechanically to pressure relief valves 216a and 216b (comprised of any well-known design and materials), which both are connected to additional high pressure resistant (well-known material) flow tubing, which connects to cylinder block 242. Directional valve assembly 214b connects to shaped flow tubings 228c and 228d (comprised of high pressure resistant well-known material), flow tubings 228c and 228d connects mechanically to cylinder block 242. Pressure gauges 224c and 224d (comprised of any well-known design and materials) are connected mechanically to flow tubings 228c and 228d. Flow tubings 228c and 228d are connected mechanically to pressure relief valves 216c and 216d (comprised of any well-known design and materials), which both are connected to additional high pressure resistant (well-known material) flow tubing, which connects to cylinder block 242. As shown in FIG. 16, the internal illustration shows cam 252, comprised of hardened steel alloy and precision ground, connected to connecting rods 250a-j, comprised of harden steel alloy and precision ground, connected to cylinder with levers 246a-b and cylinders 248a-d (cylinders comprised of hardened steel alloy and precision ground, with ring seals, comprised on well-known material). Cylinders are connected to connecting rods with cylinder pins 249a-f, comprised of hardened steel alloy and precision ground. Cylinder with levers 246a and 246b have levers that triggers the limits switches once the correct distance is reached. Cam 252 connects mechanically to rotary transmission assembly 188 which connects mechanically to transfer assembly 97. Shaft sleeve lock 118a, connects mechanically to the shaft of ac generator 150c, which has motor cooling fan 238b connected to the shaft of ac generator 150c. Heat sink 236b, comprised of aluminum alloy, press fit over ac generator 150c. Ac wire 168b connects to ac generator 150c, ac wire 168b connects to control box-2 177. As shown in FIG. 14, examples of items connected mechanically to shaft sleeve locks 118b and 118c are transmissions 240 and drive train 167b (both comprised of well-known design and materials), and dc generator 129b (comprised of well-known design and materials) with heat sink 236c (comprised of aluminum alloy) and motor cooling fan 238c (comprised of steel alloy). Power is generated from ac generator 150c, the user may now turn the toggle switch on control box-2 177 from power supply to generator. After switching the setting, sustainable torque system-3 204, is running on generator power. The power supply, battery assembly 41, is no longer required to run the system. As shown in FIG. 9, a basic schematic for connecting power supply (battery assembly 41) to the torque system motor (pump ac motor 181) and the generator (dc generator 150c). The above sustainable torque system process continues until the user desires to no longer utilize the third embodiment (As shown in FIGS. 9, 13 through 16) by removing the connection between the power source, battery assembly 41, and one of the conductive wires 160a or 160b. Another way to discontinue use, is to toggle switch 48c to the off position. With respect to the sustainable torque system-3 204 described above, it is to be realized that the optimum dimensional relationships for the parts of sustainable torque system-3 204, to include variations in size, materials, shape, form, function and manner of operation, assembly and use, are deemed readily apparent and obvious to one skilled in the art, and all equivalent relationships to those illustrated in the drawings and described in the specification are intended to be encompassed by this embodiment. Therefore, the foregoing is considered as illustrative only of the principles of the embodiment. Further, since numerous modifications and changes will readily occur to those skilled in the art, it is not desired to limit the embodiment to the exact construction and operation shown and described, and accordingly, all suitable modifications and equivalents may be resorted to, falling within the scope of the embodiment.

### Fourth Embodiment

Turning now descriptively to the drawings, in which similar reference characters denote similar elements throughout the several views, FIGS. 9, 17 through 20 illustrate a sustainable torque system-4 255. A polarity of reference numbers from FIGS. 10 and 11, sustainable torque system-2 156, are applicable to describe items within sustainable torque system-4 255. Sustainable torque system-4 255 differs with the use of pneumatic pump assembly ac 258. Pneumatic pump assembly ac 258 connects to outlet flow tubing 285 which connects to auto reciprocating pneumatic assembly 275. Additional connections are referenced in FIG. 10.

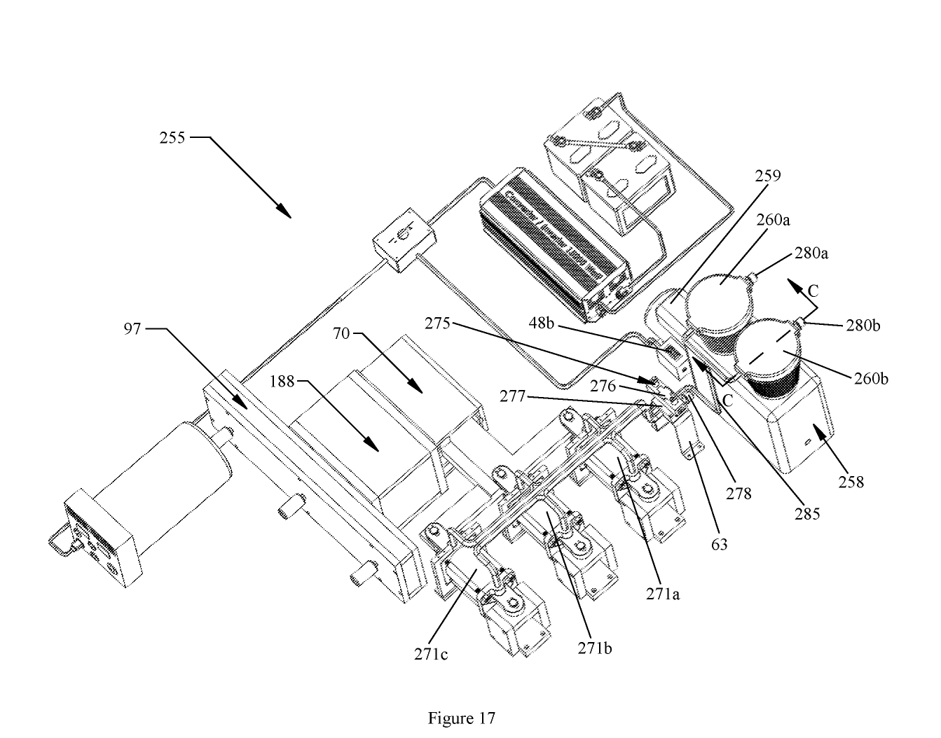

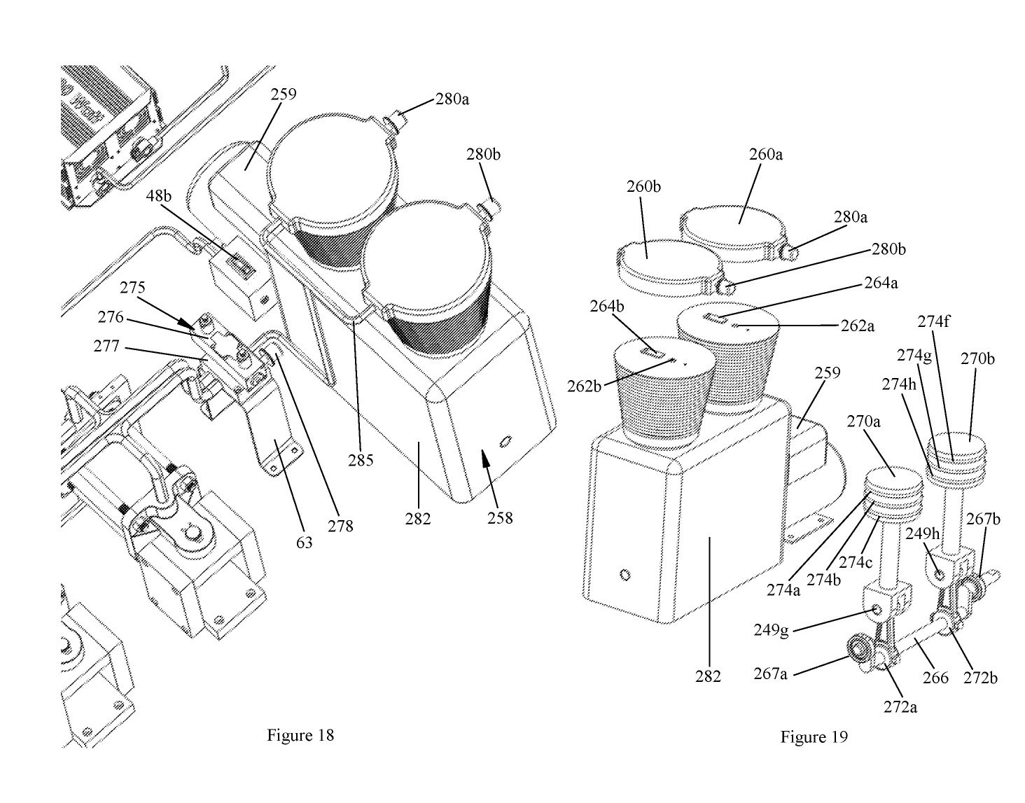

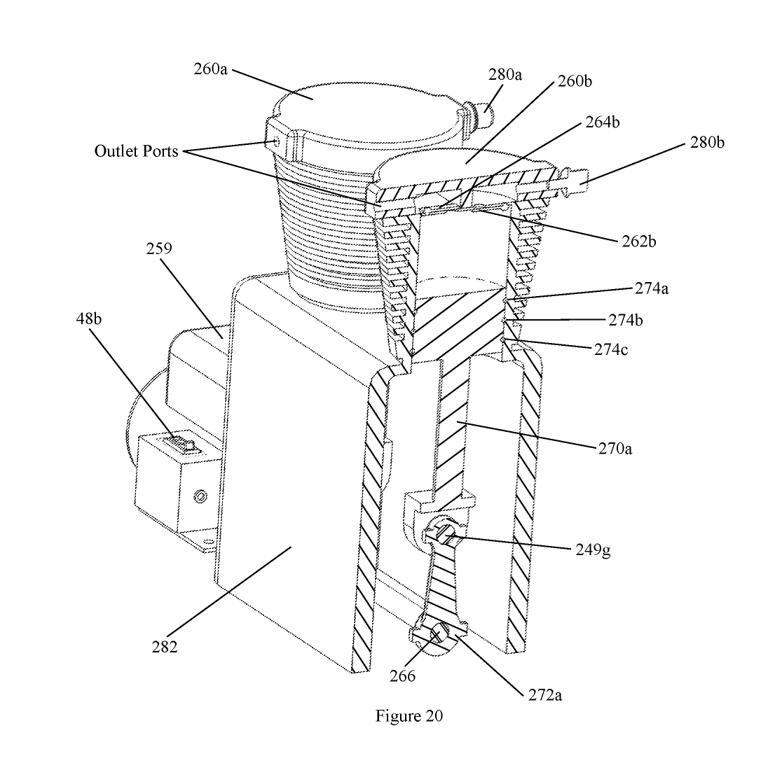

As shown in FIGS. 9, 17 through 20 of the drawings representing sustainable torque system-4 255, many of the items in this embodiment have been discussed, described and illustrated in previous embodiments. Sustainable torque system-4 255 uses a pneumatic pump assembly ac 258. Pneumatic pump assembly ac 258 comprised of pump ac motor 259, comprised of well-known design and materials, connected to on/off switch 48b, pump ac motor 259 connects with socket head cap screws to pneumatic pump case 282, comprised of steel alloy. As shown in FIGS. 18 and 19, riveted to pneumatic pump case 282 are inlet valves 262a and 262b, and outlet valves 264a and 264b, comprised of spring steel coated in rubber to create a seal. Pump caps 260a and 260b, comprised of steel alloy, are connected mechanically to pneumatic pump case 282 with socket head cap screws (not shown). Inlet filters 280a and 280b, comprised of brass and nylon fibers, press fit into pump caps 260a and 260b. Cam-straight 266, comprised of hardened steel alloy and precision ground, connects to pneumatic pump ac motor 259 with a set screw. Cam-straight 266 connects with pneumatic connecting rods 272a and 272b, comprised of hardened steel alloy and precision ground, which connects to pneumatic cylinders 270a and 270b, comprised of hardened steel alloy and precision ground. Pneumatic cylinders 270a and 270b connect to pneumatic connecting rods 272a and 272b with cylinder pins 249g and 249f, comprised of hardened steel alloy and precision ground. Pneumatic cylinders 270a and 270b having cylindrical grooves to receive seal rings 274a-f respectively, comprised of hard rubber. Cam bearings 267a and 267b (are well-known in the art) are press fit into depth holes within pneumatic pump case 282 (not shown). As shown in FIG. 20, a lateral cross section isometric view at position C-C of FIG. 19. As shown in FIGS. 17 and 18, Pump caps 260a and 260b connects mechanically to high pressure resistant outlet flow tubing 285, comprised of any well-known material, which connects mechanically to direction flow block pneumatic 277, comprised of aluminum alloy, connects by socket head cap screws to auto reciprocating pneumatic valve 276 (provides a predetermined adjustable pressure setting, once reach reverses the flow direction, comprised of well-known design and material). Exhaust filter 278, comprised of brass and nylon fibers, screw fit into direction flow block pneumatic 277 exhaust port. Support bracket 63, comprised of steel alloy, connects to direction flow block pneumatic 277 with socket head cap screws. Flow block pneumatic 277 connects mechanically to flow tubing, which connects to pneumatic cylinder assembly 271a-c, comprised of well-known design and materials. The above sustainable torque system process continues until the user desires to no longer utilize the fourth embodiment (As shown in FIGS. 9, 10, 17 through 20) by removing the connection between the power source, battery assembly 41 and one of the conductive wires 160a or 160b. Another way to discontinue use, is to toggle on/off switch 48b to the off position. With respect to the sustainable torque system-4 255 described above, it is to be realized that the optimum dimensional relationships for the parts of sustainable torque system-4 255, to include variations in size, materials, shape, form, function and manner of operation, assembly and use, are deemed readily apparent and obvious to one skilled in the art, and all equivalent relationships to those illustrated in the drawings and described in the specification are intended to be encompassed by this embodiment. Therefore, the foregoing is considered as illustrative only of the principles of the embodiment. Further, since numerous modifications and changes will readily occur to those skilled in the art, it is not desired to limit the embodiment to the exact construction and operation shown and described, and accordingly, all suitable modifications and equivalents may be resorted to, falling within the scope of the embodiment.

### Fifth Embodiment

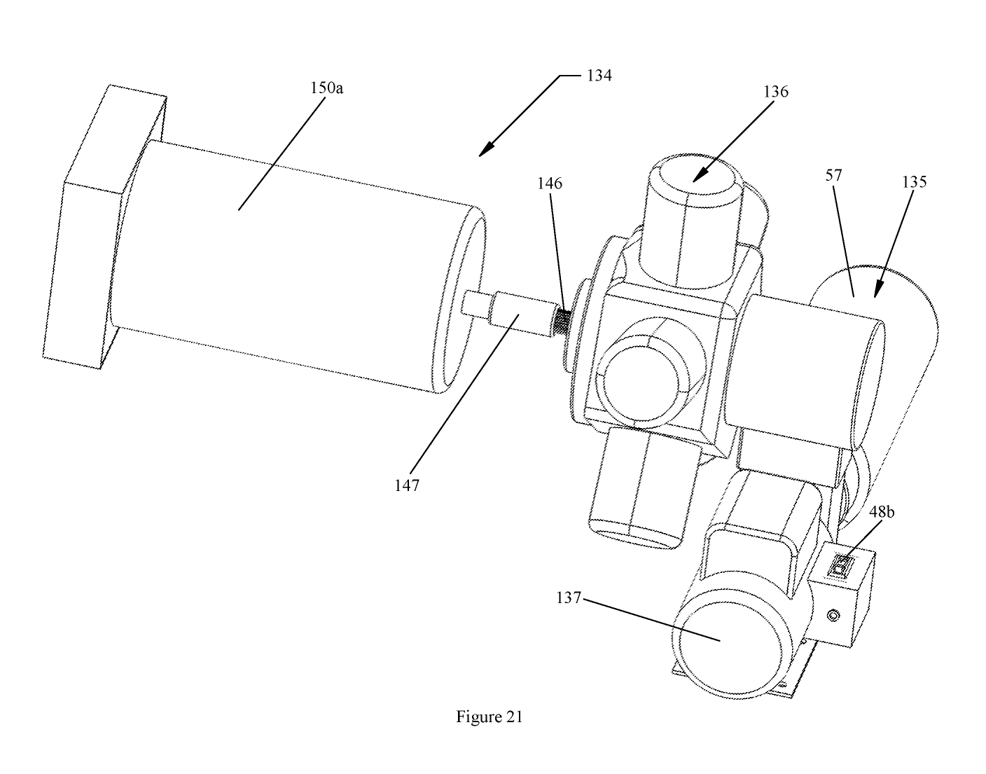

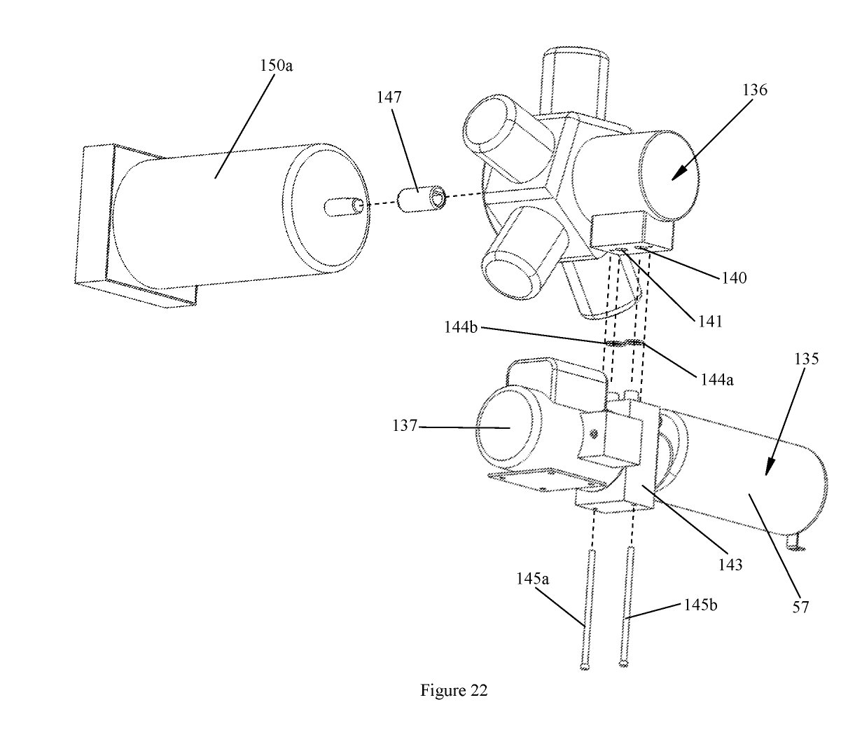

Turning now descriptively to the drawings, in which similar reference characters denote similar elements throughout the other embodiments and FIGS. 9, 10, 11, 21 and 22, illustrate a sustainable torque system-5 134. A polarity of reference numbers from FIGS. 10 and 11, sustainable torque system-2 156, are applicable to describe items within sustainable torque system-5 134. Sustainable torque system-5 134 uses radial piston motor 136. Radial-pump assembly 135 connects to radial piston motor 136. Directional flow block 143, mates to radial piston motor 136. Radial piston motor 136 connects mechanically to ac generator 150a. Ac generator 150a connects to ac wire 168b (referencing FIG. 10 for connections) which connects to control box-1 176, which connects to ac wire 168c, which connects to pump motor ac 137 (referencing FIGS. 21 and 22). Additional connections are referenced in FIGS. 9 through 11, drawings representing sustainable torque system-2 156. As shown in FIGS. 21 and 22, radial-pump assembly 135 is comprised of pump motor ac 137 (comprised of well-known design and materials), on/off switch 48b (comprised of well-known design and materials), directional flow block 143 (comprised of aluminum alloy), mechanical pump assembly (not shown) and pump reservoir 57. Flow block seals 144a and 144b, comprised of hardened rubber or silicon, socket head cap screws 145a and 145b, comprised of any well-known material, slip fits through direction flow block 143, fastening into radial piston motor 136. Radial piston motor 136 (comprised of well-known design and materials) has a crankshaft 146 (comprised of hardened steel alloy), inlet port 140 and outlet port 141 (directional fluid flow). Crankshaft 146 connects to crank sleeve 147 (comprised of steel alloy) with a set screw (not shown). Crank sleeve 147 connects to the shaft of ac generator 150a with a set screw. Once other components are added from previous embodiments, the above sustainable torque system-5 134 process continues until the user desires to no longer utilize the fifth embodiment (As shown in FIGS. 9 and 10) by removing the connection between the power source, battery assembly 41 and one of the conductive wires 160a or 160b. Another way to discontinue use, is to toggle switch 48b, to the off position. With respect to the sustainable torque system-5 134 described above, it is to be realized that the optimum dimensional relationships for the parts of sustainable torque system-5 134, to include variations in size, materials, shape, form, function and manner of operation, assembly and use, are deemed readily apparent and obvious to one skilled in the art, and all equivalent relationships to those illustrated in the drawings and described in the specification are intended to be encompassed by this embodiment. Therefore, the foregoing is considered as illustrative only of the principles of the embodiment. Further, since numerous modifications and changes will readily occur to those skilled in the art, it is not desired to limit the embodiment to the exact construction and operation shown and described, and accordingly, all suitable modifications and equivalents may be resorted to, falling within the scope of the embodiment.

The sustainable torque system of the enclosed embodiments illustrate a system for the automobile industry. The embodiments may be applied to a wide range of industries including but not limited to the transportation industry (i.e., buses, trucks, rail, etc.), residential homes, commercial buildings, industrial plants, marine vehicles, aeronautics, etc.

### DRAWINGS

### Reference Numerals

| | |
|---|---|
| 30. | Sustainable Torque System-1 |
| 31. | |
| 32. | |
| 33. | |
| 34. | |
| 35. | |
| 36. | |
| 37. | |
| 38. | |
| 39. | |
| 40. | Battery (a-b) |
| 41. | Battery Assembly |
| 42. | |
| 43. | Cross Conductive Wire |
| 44. | Conductive Wire (a-b) |
| 45. | DC Wire (a-b) |
| 46. | Conductive Wire Short |
| 47. | |
| 48. | ON/OFF Switch (a-c) |
| 49. | Hydraulic Pump Assembly DC |
| 50. | Hydraulic Pump DC Motor |
| 51. | |
| 52. | Directional Flow Block Long (a-b) |
| 53. | Directional Flow Block Short (a-b) |
| 54. | |
| 55. | Flow Tubing (a-b) |
| 56. | |
| 57. | Pump Reservoir |
| 58. | Auto Reciprocating Valve Assembly |
| 59. | Automatic Reciprocating Valve |
| 60. | |
| 61. | |
| 62. | |
| 63. | Support Bracket |
| 64. | Flow Tubing Large (a-b) |
| 65. | |
| 66. | Cylinder Assembly |
| 67. | Bracket Rod End |
| 68. | Cylinder Bracket (a-b) |
| 69. | Cylinder Bracket Base |
| 70. | Linear To Rotational Box |
| 71. | Housing Top Plate |
| 72. | Housing Back Plate |
| 73. | Housing Side Plate |
| 74. | Housing Bottom Plate |
| 75. | Housing Support Plate |
| 76. | Housing Mount Plate |
| 77. | Housing Front Plate |
| 78. | Main Shaft |
| 79. | Bearing Assembly-2 (a-b) |
| 80. | |
| 81. | Spur Gear (a-b) |
| 82. | |
| 83. | Clutch Roller Bearing (a-b) |
| 84. | |
| 85. | Single Connect Arm |
| 86. | Rack Gear (a-b) |
| 87. | |
| 88. | Rack Gear Holder (a-b) |
| 89. | |
| 90. | Pin Clip (a-f) |
| 91. | |
| 92. | Pin (a-c) |
| 93. | |
| 94. | Ways Long (a-b) |
| 95. | |
| 96. | Ways Short (a-b) |
| 97. | Transfer Assembly |
| 98. | Top Plate |
| 99. | Bottom Plate |
| 100. | Back Plate |
| 101. | Front Plate |
| 102. | Side Plate (a-b) |
| 103. | |
| 104. | Gear (a-e) |
| 105. | |
| 106. | |
| 107. | |
| 108. | |
| 109. | Bearing Assembly (a-j) |
| 110. | |
| 111. | |
| 112. | |
| 113. | |
| 114. | Drive Shaft (a-c) |
| 115. | Short Shaft (a-b) |
| 116. | |
| 117. | |
| 118. | Shaft Sleeve Lock (a-c) |
| 119. | |
| 120. | |
| 121. | |
| 122. | Cylinder Support Top Plate |
| 123. | Cylinder Support Side Plate (a-b) |
| 124. | |
| 125. | Cylinder Support Base Plate |
| 126. | |
| 127. | |
| 128. | |
| 129. | DC Generator (a-b) |
| 130. | |
| 131. | |
| 132. | |
| 133. | |
| 134. | Sustainable Torque System-5 |
| 135. | Radial-Pump Assembly |
| 136. | Radial Piston Motor |
| 137. | Pump Motor AC |
| 138. | |
| 139. | |
| 140. | Inlet Port |
| 141. | Outlet Port |
| 142. | |
| 143. | Directional Flow Block |
| 144. | Flow Block Seal (a-b) |
| 145. | Socket Head Cap Screw (a-b) |
| 146. | Crankshaft |
| 147. | Crank Sleeve |
| 148. | |
| 149. | |
| 150. | AC Generator (a-c) |
| 151. | |
| 152. | |
| 153. | |
| 154. | |
| 155. | |
| 156. | Sustainable Torque System-2 |
| 157. | Solar Panel |
| 158. | Solar Wire (a-c) |
| 159. | Solar Toggle Switch On/Off |
| 160. | Inverter Wire (a-b) |
| 161. | |
| 162. | Throttle/Motor Controller |
| 163. | DC Motor |
| 164. | Inverter/Converter |
| 165. | Throttle |
| 166. | Throttle Wire |
| 167. | Drive Train (a-b) |
| 168. | AC Wire (a-d) |
| 169. | DC Controller Wire (a-b) |
| 170. | Controller Motor Wire (a-b) |
| 171. | |
| 172. | Charging Wire (a-b) |
| 173. | Charging Wire Long (a-b) |
| 174. | |
| 175. | |
| 176. | Control Box-1 |
| 177. | Control Box-2 |
| 178. | |
| 179. | |
| 180. | Hydraulic Pump Assembly AC |
| 181. | Pump AC Motor |
| 182. | Flow Tubing Long (a-b) |
| 183. | Multiple Cylinder Assembly |
| 184. | Cylinder (a-c) |
| 185. | |
| 186. | Multiple Connect Arm |
| 187. | |
| 188. | Rotary Transmission Assembly |
| 189. | |
| 190. | Transmission Side Plate (a-b) |
| 191. | Transmission Front Plate |
| 192. | Transmission Back Plate |
| 193. | Transmission Plate (a-b) |
| 194. | Transmission Gear Large (a-c) |
| 195. | |
| 196. | |
| 197. | |
| 198. | Transmission Gear Small (a-c) |
| 199. | Transition Shaft |
| 200. | |
| 201. | End Gear Large |
| 202. | End Gear Small |
| 203. | AC/DC Converter and Charger |
| 204. | Sustainable Torque System-3 |
| 205. | Hydraulic Pump Assembly AC-2 |
| 206. | Directional Valve Power Supply Wire |
| 207. | DC/DC Converter and Charger |
| 208. | Pump Motor Power Wire |
| 209. | |
| 210. | Directional Valve Power Supply |
| 211. | |
| 212. | Directional Valve Controller |
| 213. | |
| 214. | Directional Valve Assembly (a-b) |
| 215. | |
| 216. | Relief Valve (a-d) |
| 217. | |
| 218. | |
| 219. | Limit Switch (a-d) |
| 220. | |
| 221. | |
| 222. | Limit Switch Bracket (a-b) |
| 223. | |
| 224. | Pressure Gauge (a-d) |
| 225. | |
| 226. | Main Flow Tubing (a-b) |
| 227. | |
| 228. | Shaped Flow Tubing (a-d) |
| 229. | |
| 230. | |
| 231. | Reservoir Channel |
| 232. | Reservoir Cover Plate |
| 233. | Reservoir Drain Cap |
| 234. | Reservoir Fill Cap |
| 235. | |
| 236. | Heat Sink (a-c) |
| 237. | |
| 238. | Motor Cooling Fan (a-c) |
| 239. | |
| 240. | Transmission |
| 241. | |
| 242. | Cylinder Block |
| 243. | |
| 244. | Cylinder Block Plate (a-b) |
| 245. | |
| 246. | Cylinder With Lever (a-b) |
| 247. | |
| 248. | Cylinder (a-d) |
| 249. | Cylinder Pin (a-h) |
| 250. | Connecting Rod (a-f) |
| 251. | |
| 252. | Cam |
| 253. | |
| 254. | |
| 255. | Sustainable Torque System-4 |
| 256. | |
| 257. | |
| 258. | Pneumatic Purnp Assembly AC |
| 259. | Pneumatic Pump AC Motor |
| 260. | Purnp Cap (a-b) |
| 261. | |
| 262. | Inlet Valve (a-b) |
| 263. | |
| 264. | Outlet Valve (a-b) |
| 265. | |
| 266. | Cam-Straight |
| 267. | Cam Bearing (a-b) |
| 268. | |
| 269. | |
| 270. | Pneumatic Cylinder (a-b) |
| 271. | Pneumatic Cylinder Assembly (a-c) |
| 272. | Pneumatic Connecting Rod (a-b) |
| 273. | |
| 274. | Seal Ring (a-f) |
| 275. | Auto Reciprocating Pneumatic Assembly |
| 276. | Auto Reciprocating Valve Pneumatic |
| 277. | Directional Flow Block Pneumatic |
| 278. | Exhaust Filter |
| 279. | |
| 280. | Inlet Filter (a-b) |
| 281. | |
| 282. | Pneumatic Pump Case |
| 283. | |
| 284. | |
| 285. | Outlet Flow Tubing |
| 286. | |
| 287. | |
| 288. | |
| 289. | |
| 290. | |
| 291. | |
| 292. | |
| 293. | |
| 294. | |
| 295. | |
| 296. | |
| 297. | |

### Operation

In use of the first embodiment FIGS. 1 through 8, the user toggles the on/off switch 48a to on position. Energy from power source, battery 40a powers hydraulic pump assembly dc 49. Hydraulic pump assembly dc 49 pumps hydraulic fluid through auto reciprocating valve assembly 58 to cylinder assembly 66. Linear stroke motion from cylinder assembly 66 is converted to rotational torque. Rotational torque from shaft sleeve lock 118a rotates main shaft of dc generator 129a creating energy. Energy created from dc generator 129a flows along conductive wires 44a, 44b, 46 and on/off switch 48a to the hydraulic pump assembly dc 49. Power source, battery 40a may now be disconnected from either one of conductive wires 44a or 44b. Sustainable torque system-1 30 is powered by dc generator 129a. To power off sustainable torque system-1 30, toggle on/off switch 48a to off position.

In use of the second embodiment FIGS. 9 through 11, the user rotates lever on control box-1 176 to power source setting. Energy from battery 40a and battery 40b routes to inverter/converter 164 via conductive wires 160a and 160b. Ac wire 168a routes power from inverter/converter 164 to control box-1 176, power routes from control box-1 176 to hydraulic hump assembly ac 180. The user toggles on/off switch 48b to on position. Hydraulic pump assembly ac 180 pumps hydraulic fluid to cylinders 164a, 164b and 164c, linear stroke motion from cylinders are converted to rotational torque. Rotary transmission 188 steps up or steps down (depending on requirements) the rpm derived from main shaft 78. Rotational torque from shaft sleeve lock 118a rotates main shaft of ac generator 150b creating energy. Energy from ac generator 150b travels to control box-1 176 via ac wire 168b. The user rotates lever on control box-1 176 to generator setting. Sustainable torque system-2 156 is powered by ac generator 150b. To power off sustainable torque system-2 156, toggle on/off switch 48b to off position. In use of other embodiments included in various FIGS., as to further discussion of the manner of usage and operation of other embodiments, the same should be apparent from the above description. Accordingly, no further discussion relating to the manner of usage and operation will be provided. With respect to the above descriptions then, it is to be realized that the optimum dimensional relationships for the parts of the embodiments, to include variations in size, materials, shapes, form, function and manner of operation, assembly and use, are deemed readily apparent and obvious to one skilled in the art, and all equivalent relationships to those illustrated in the drawings and described in the specification are intended to be encompassed by the embodiments.

Therefore, the foregoing is considered as illustrative of the principles of the embodiments. Further, since numerous modifications and changes will readily occur to those skilled in the art, it is not desired to limit the embodiments to the exact construction and operation shown and described, and accordingly, all suitable modifications and equivalents may be resorted to, falling within the scope of the embodiments. Accordingly, the reader will see that the sustainable torque systems of various embodiments can be used to create sustainable torque without the need of a combustible engine, or a large number of batteries as the continued energy source providing the main power to a vehicle that eventually will need to be plugged in and recharged. Although the description above contains many specifications, these should not be construed as limiting the scope of the embodiments but as merely providing illustrations of some of several embodiments. For example, the cylinder layout could utilize one or multiple units; multiple pumps may be used to create additional force, etc.

I claim:

1. A sustainable torque system, comprising:
a. a power supply connected by conductive material-a to a torque system;
b. said torque system connects mechanically to a generator; and
c. said generator connected by conductive material-b to said torque system;
d. whereby energy from said generator powers said torque system and said power supply may now be disengaged.

2. The sustainable torque system of claim 1, wherein said conductive material-a is:
a. copper wire inner with insulated outer material with fittings to connect to mating part, or
b. any conductive material with fittings to connect to mating part.

3. The sustainable torque system of claim 1, wherein said torque system is:
a. a electric motor pump system connected by plumbing to a directional flow assembly which connects by additional plumbing to a cylinder assembly mechanically connected to rotary transmission assembly, or
b. a electric motor pump system which pumps fluid connected mechanically to a cylinder assembly.

4. The sustainable torque system of claim 1, wherein said conductive material-b is:
a. copper wire inner with insulated outer material with fittings to connect to mating part, or
b. any conductive material with fittings to connect to mating part.

5. A sustainable torque system, comprising:
a. a power supply connected by conductive material-c to a inverter/converter;
b. said inverter/converter connected by conductive material-d to a electrical control box;
c. said electrical control box connected by conductive material-e to a torque system;
d. said torque system connects mechanically to a rotary transmission;
e. said rotary transmission connects mechanically to a generator;
f. said generator connected by conductive material-f to said electrical control box;
g. said generator provides energy to said torque system routed through said electrical control box;
h. whereby said power supply may now be disengaged.

6. The sustainable torque system of claim 5, wherein said conductive material-c is:
a. copper wire inner with insulated outer material with fittings to connect to mating part, or
b. any conductive material with fittings to connect to mating part.

7. The sustainable torque system of claim 5, wherein said inverter/converter is:
a. a device used to convert direct current to direct current, or
b. a device used to convert direct current to alternating current, or
c. a device used to convert alternating current to alternating current, or
d. a device used to convert alternating current to direct current.

8. The sustainable torque system of claim 5, wherein said conductive material-d is:
a. copper wire inner with insulated outer material with fittings to connect to mating part, or
b. any conductive material with fittings to connect to mating part.

9. The sustainable torque system of claim 5, wherein said conductive material-e is:
a. copper wire inner with insulated outer material with fittings to connect to mating part, or
b. any conductive material with fittings to connect to mating part.

10. The sustainable torque system of claim 5, wherein said torque system is:
a. a electric motor pump system connected by plumbing to a directional flow assembly connected by additional plumbing to a cylinder assembly, or
b. a electric motor pump system which pumps fluid connected mechanically to a cylinder assembly.

11. The sustainable torque system of claim 5, wherein said conductive material-f is:
a. copper wire inner with insulated outer material with fittings to connect to mating part, or
b. any conductive material with fittings to connect to mating part.
